(19) United States
(12) Patent Application Publication
(10) Pub. No.: US 2015/0356530 A1
(43) Pub. Date: Dec. 10, 2015

(54) TRANSACTIONAL SOCIAL MEDIA PLATFORM SYSTEM AND METHOD

(71) Applicant: Nnamudi Mokwunye, Florence, AL (US)

(72) Inventor: Nnamudi Mokwunye, Florence, AL (US)

(21) Appl. No.: 14/297,620

(22) Filed: Jun. 5, 2014

(51) Int. Cl. G06Q 20/12; G06Q 50/00; G06Q 30/02; G06Q 20/10

(52) U.S. Cl. CPC G06Q 20/1235; G06Q 20/10; G06Q 50/01; G06Q 30/0206

(57) ABSTRACT

A transactional social media platform. The transactional social media platform includes a social graph representative of relationships within the transactional social media platform. The represented relationships include consumer users and vendor users on nodes of the transactional social media platform that might also incorporate existing social media platforms. Consumer users may access video content from vendor users at a cost based on a number of factors. Upon providing consumer user access to video content, the system automatically charges or deducts the determined base cost from a corresponding consumer user account on the transactional social media platform.

### CLAIM OF PRIORITY

The present invention claims priority from U.S. Provisional Patent Application No. 61/878,971, filed Sep. 19, 2013, Attorney Docket No: 13-0492.01 entitled “Transactional Social Media Platform.”

### CROSS REFERENCE TO RELATED APPLICATIONS

The present invention is related to (1) U.S. patent application Ser. No. Jun. 5, 2014, entitled TRANSACTIONAL SOCIAL MEDIA PLATFORM SYSTEM AND METHOD WITH REVENUE SHARE, Attorney Docket. No. PVINE.002US; and (2) U.S. patent application Ser. No. ______, filed Jun. 5, 2014, entitled TRANSACTIONAL SOCIAL MEDIA PLATFORM SYSTEM AND METHOD WITH USER INVITE, Attorney Docket No PVINE.003US both of which are concurrently filed herewith and fully incorporated by reference as if fully set forth in the present specification.

### COMPUTER PROGRAM LISTING APPENDIX

A computer program listing appendix is provided including the following ASCII files: channellist.txt, 4.66k; _upload.text, 3.81k; main.txt 2.35k; socialnetwork.txt 2.46k; uploadcontroller.txt 1.77k; uploadinvitecontroller.txt 2.15k; vine.txt 3.51k; vinestabcontroller.txt 1.94; balanceaccount.txt 2.84k; balancetransaction.txt 5.99; balancetransactiondestination.txt 2.4k, all of the files created Jun. 4, 2014. The information is hereby incorporated by reference as if set forth in full in this application for all purposes. A portion of the disclosure recited in this application contains material which is subject to copyright protection. Specifically, the computer program listing appendix and possibly other portions of the application may recite or contain source code, data or other functional text. The copyright owner has no objection to the facsimile reproduction of the functional text; otherwise all copyright rights are reserved.

### BACKGROUND OF THE INVENTION

The present invention relates generally to computer and communication systems and methods and more specifically to computer and communication systems and methods that process online social network data for an online transaction social media platform.

Online “direct to consumer” delivery of video content continues to proliferate, providing growth opportunities for monetizing video content such as movies, music videos, amateur home-based videos and the like. A video content provider wishing to monetize video content can use any number of conventional online delivery platforms. As an example, a video content provider can employ a non-subscriber advertising-based platform such as YouTube™ and the like.

The content provider would begin by creating and uploading the video content to the online platform for viewing by consumers. As consumers view the video content, the online platform would deliver advertisements to engage viewers and generate revenue because the online platform is based on an advertising model.

The more consumers view the video content, the more advertising is presented to them and the more revenue inures to the content provider. In other words, if the video content goes viral, the content provider can expect to generate some revenue. If the video content is unpopular or does not attract substantial viewing, the content provider generates little or no revenue.

Another type of online platform that can be used by a content provider wishing to monetize video content is a subscriber-based platform such as Netflix™ or the like. Here, the content provider simply provides the content to the third party online platform (such as Netflix™), and as subscribers request the video content, corresponding revenue based on the requested video content is generated. The revenue generated depends upon the number of subscribers and the number of times those subscribers view the video content.

Further yet, another online platform that can be utilized by content providers is a social networking platform (Facebook,™ Twitter,™ etc). Here, the content provider might simply wish to distribute such content for informational, educational or entertainment purposes.

It is within the aforementioned context that a need for the present invention has arisen. Thus, there is a need to address one or more of the perceived or implied disadvantages of conventional systems and methods, and the present invention meets this need.

### BRIEF SUMMARY OF THE INVENTION

Various aspects of a transactional social media platform system and method can be found in exemplary embodiments of the present invention.

In a first embodiment, the transactional social media platform includes one or more computing devices establishing a social graph that represents relationships between users, participants or “viners” of an online social network, as well as degrees of separation between such user viners. In one embodiment, the transactional social media platform may communicably incorporate existing social media networks such as Twitter™ or Facebook™ etc. so that the transactional social media platform augments its communication access to reach contacts beyond the transaction social media platform.

Another advantage of the present invention is that the transactional social media platform infrastructure is structured around distribution of and access to video content such as music videos, movies, etc. Thus, in a preferred embodiment, unlike existing social media platforms that have general-type users unrelated to video content, the transactional social media platform of the present invention creates and sets apart two categories of user viners around video content.

The first category is consumer viners that consume but cannot upload video content. Each consumer account is configured to deny or block all requests by consumer viners to upload video content.

The second user category built around video content is vendor viners. Vendor viners are accounts that upload video content for distribution to consumer viner accounts. The transactional social video platform thus operates with two user categories within a social media context: consumer viners seeking video content and vendor viners offering video content for rent or purchase. The platform then facilitates commercial transactions between its two user categories.

In one embodiment, to facilitate such transactions, the platform employs an algorithm that utilizes a number of factors to automatically determine a base price for uploaded video content. Among other factors, the algorithm may use |S|, the quantity of all SD (Standard Definition) encoded videos; cₕ, the cost of HD (High Definition) encoding per min ($); SPE, a spread constant, etc. Once the price of the video content is determined, consumer viners may access and view such video content after which the corresponding consumer viner accounts are charged.

In this manner, the transactional social media platform of the present invention facilitate online “direct to consumer” providing dynamic growth opportunities for monetizing video content. Video content providers wishing to monetize their video content online need not rely on conventional subscriber or advertising-based platforms; or on existing social media networks for that matter. Content providers can utilize the transactional social media platform of the present invention to create their own consumer base from which direct revenues may be generated.

A further understanding of the nature and advantages of the present invention herein may be realized by reference to the remaining portions of the specification and the attached drawings. Further features and advantages of the present invention, as well as the structure and operation of various embodiments of the present invention, are described in detail below with respect to the accompanying drawings. In the drawings, the same reference numbers indicate identical or functionally similar elements.

### BRIEF DESCRIPTION OF THE DRAWINGS

FIG. 1A illustrates a transactional social media communication system (or transactional social media platform) according to an exemplary embodiment of the present invention.

FIG. 1B illustrates a specific representation of the transactional social media communication system of FIG. 1B according to an exemplary embodiment of the present invention.

FIG. 2 illustrates components of a transactional social media server system 106 according to an exemplary embodiment of the present invention.

FIG. 3 illustrates a transactional social media interface according to an exemplary embodiment of the present invention.

FIG. 4 illustrates a vendor viner store interface screenshot according to an exemplary embodiment of the present invention.

FIG. 5 illustrates a registration method according to an exemplary embodiment of the present intention.

FIG. 6A illustrates a vendor registration form according to an exemplary embodiment of the present invention.

FIG. 6B illustrates a consumer registration form according to an exemplary embodiment of the present invention.

FIG. 7A illustrates a vendor viner channel form according to an exemplary embodiment of the present invention.

FIG. 7B illustrates a consumer channel form according to an exemplary environment of the present invention.

FIG. 8 illustrates a video upload interface screenshot according to an exemplary embodiment of the present invention.

FIG. 9 illustrates a video content label interface screenshot according to an exemplary embodiment of the present invention.

FIG. 10A illustrates a content-view invite interface screenshot according to an exemplary embodiment of the present invention.

FIG. 10B illustrates a social graph according to an exemplary embodiment of the present invention.

FIG. 10C illustrates a revenue topology according to an exemplary embodiment of the present invention.

FIG. 10D further illustrates the revenue topology of FIG. 10C with reference to the revenue sharing algorithm according to an exemplary embodiment of the present invention.

FIG. 11 illustrates a vendor-on-vendor interface screenshot according to an exemplary embodiment of the present invention.

FIG. 12 illustrates expanded vendor-on-vendor interface according to an exemplary embodiment of the present invention.

FIG. 13 illustrates vendor's own interface screenshot according to an exemplary embodiment of the present invention.

FIG. 14 illustrates vendor viner's own interface screenshot according to an exemplary embodiment of the present invention.

FIG. 15 illustrates a screenshot of vendor viner's own interface screenshot according to an exemplary embodiment of the present invention.

FIG. 16 illustrates a vendor viner's own interface screenshot according to an exemplary embodiment of the present invention.

FIG. 17 illustrates a vendor viner's own interface screenshot according to an exemplary embodiment of the present invention.

FIG. 18 illustrates a vendor-on-consumer interface screenshot according to an exemplary embodiment of the present invention.

FIG. 19 illustrates a consumer's own channel interface screenshot according to an exemplary embodiment of the present invention.

FIG. 20 illustrates a consumer's own channel interface screenshot according to an exemplary embodiment of the present invention.

FIG. 21 illustrates a sports live event guide interface screenshot according to an exemplary embodiment of the present invention.

FIG. 22 illustrates a consumer's own channel apps interface screenshot according to an exemplary embodiment of the present invention.

FIG. 23 illustrates a consumer's own channel library interface screenshot according to an exemplary embodiment of the present invention.

FIG. 24 illustrates an edit video information interface screenshot according to an exemplary embodiment of the present invention.

FIG. 25 illustrates a video view invites interface screenshot according to an exemplary embodiment of the present invention.

FIG. 26 illustrates a rent-buy video interface screenshot according to an exemplary embodiment of the present invention.

FIG. 27 illustrates a video rent-buy payment interface according to an exemplary embodiment of the present invention.

FIG. 28A shows a typical computer 10 such as would be operated by a user on the Internet.

FIG. 28B shows subsystems of the computer of FIG. 28A.

### DETAILED DESCRIPTION OF THE INVENTION

Reference will now be made in detail to the embodiments of the present invention, examples of which are illustrated in the accompanying drawings. While the invention will be described in conjunction with one or more embodiments, it will be understood that they are not intended to limit the invention to the discussed embodiments. On the contrary, the invention is intended to cover several alternatives, modifications and equivalents which may be included within the scope and spirit of the present invention that is defined by the appended claims. Furthermore, many specific details are set forth to provide a thorough understanding of the present invention; however, it will be obvious to one of ordinary skill in the art that the present invention may be practiced without specific details. In some other instances, well-known procedures, components and circuits have not been described in detail so as not to unnecessarily obscure aspects of the present invention.

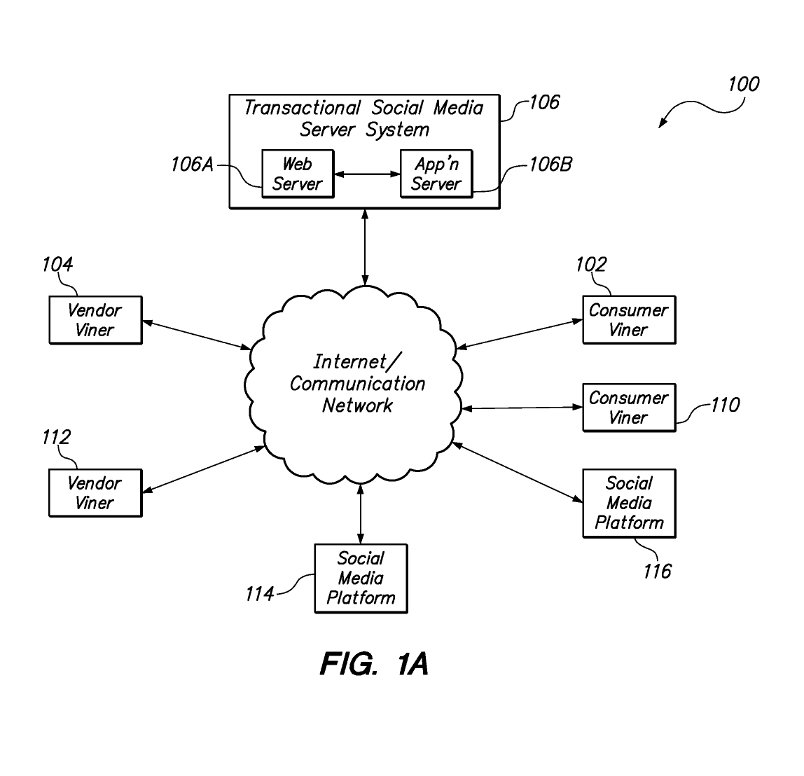

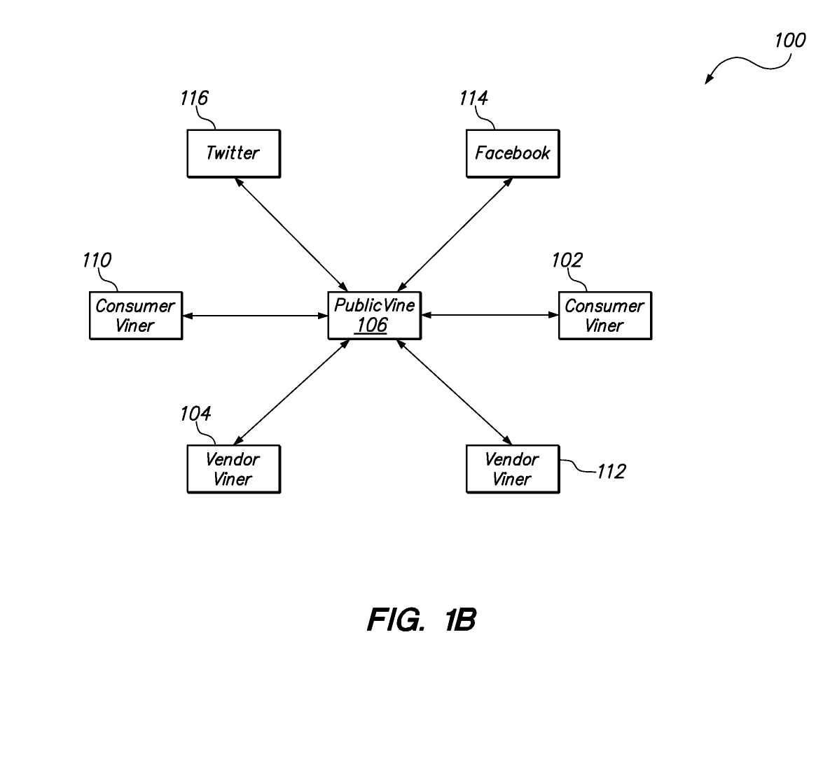

FIG. 1A illustrates transactional social media communication system (or transactional social media platform) 100 according to an exemplary embodiment of the present invention.

In FIG. 1A, among other components, transactional social media communication system 100 comprises a first consumer viner 102 and a first vendor viner 104 as shown. As will be further discussed, the term “viner” refers to a participant in the transactional social media platform of the present invention.

As shown, consumer viner 102 and vendor viner 104 are communicably coupled to transactional social media server system or (transactional server system) 106 via Internet/communication network 108. Although not shown, Internet/communication network 108 represents any distributed network (wired, wireless or otherwise) for the transmission and receipt of data between two points. The system of the present invention can work effectively with any possible distribution of interconnected processors regardless of the specific topology, hardware and protocols used.

Here, consumer viner 102 is any person or entity that is a participant in a social media network. In other words, consumer viner 102 is a social media participant that wishes to interact with other users to share and exchange ideas and information within the transactional social media communication system 100.

Consumer viner 102 also wishes to view and access video content from others as well as pay for any and all content that is consumed. Although not shown, consumer viner 102 may utilize a mobile device, desktop device or the like for participating in the transaction social media platform.

Vendor viner 104 is a person or entity that wishes to commercialize and monetize video content by distributing said video content to consumer viners within transactional social media communication system 100. That is, vendor viner 104 is that entity or person with a profit motive in distributing video content. Although not shown, vendor viner 104 may utilize a mobile device, webpage device or desktop or other comparable device to access transactional social media server system 106.

Without limitation, video content for transactions may include music videos, feature movies, home based videos, educational and information videos and the like. Such video content is provided by vendor viner 104 for eventual distribution and purchase by social media participants such as consumer viner 102.

In FIG. 1A, as indicated by its name, transactional social media server system 106 is a social media platform that facilitates exchange of ideas, profiles, etc. and communicably incorporates existing social media systems such as Facebook,™ Twitter,™ etc. into its own platform and monetizes video content for video content producers within the viral context of a social media setting.

Among other components, transactional social media server system 106 further comprises web server 106A and application server 106B. Web server 106A can be a combination of processors and/or software capable of communicating with vendor viner 104 and consumer viner 102. Web server 106A may host a website (not shown) such as www.publicvine.com, via which consumer viner 102 and vendor viner 104 can access transactional social media server system 106.

Here, web server 106A may respond to HTTP or webpage requests from users and in conjunction with application server 106B provide responses such responses as video content from vendor viner 104 to a requesting consumer viner 102 for viewing. Application server 106B can also be a combination of hardware and software dedicated to managing the social media platform. Any suitable web server or application server consistent with the spirit and scope of the present invention can be utilized.

Referring now to additional components in FIG. 1A, transactional social media communication system 100 further comprises a second consumer viner 110 and a second vendor viner 112 both communicably coupled to transactional social media server system 106. Here, consumer viner 110 may also be a person, entity or social media network participant. Consumer viner 110 wishes to exchange ideas with other system participants and wishes to view and pay for video content received from vendor viners including vendor viner 112 and/or vendor viner 104 within the communication system.

Consumer viner 110 might be a child participant in contrast to consumer viner 102, who might be an adult participant. Thus, the transactional social media communication system 100 of the present invention is intended to encompass a multiplicity of consumer types, ages and backgrounds because the system of the present invention includes a protective mechanism that prevents children from viewing inappropriate video content.

Although not shown, consumer viner 110 may also access the transactional social media server system via a mobile device, a tablet, a desktop or any comparable type device; moreover, consumer viners other than consumer viners 102 and 110 and vendor viners other than vendor viners 104 and 112 may be part of transactional social media communication system 100. The system of the present invention is also not limited to a single content provider, but a multiplicity of content providers can participate within the transactional social media system.

In FIG. 1A, transactional social media communication system 100 further includes a first social media platform 114 and a second social media platform 116 both of which are communicably coupled to transactional social media server system 106. In the present example, social media platform 114 is an existing social media network such as Facebook™. Social media platform 116 is also an existing social media platform such as Twitter™.

Thus, unlike conventional social media systems that comprise a single proprietary platform, transactional social media communication system 100 communicably integrates existing social media platforms within its network, significantly increasing the reach and distribution of content providers to consumers and users of other existing social media platforms.

In use, all viners that have become registered can participate in the system. Registration is initiated when vendor viner (prospective) 104 sends a registration request to become a participant in the transactional social media communication system. The same goes for vendor viner 112, who communicates a registration request to initiate registration. The registration request is received by transactional social media server system 106, which creates an account and a corresponding user ID for use by either vendor viners 104 and 112.

In a similar fashion, upon request for registration, corresponding accounts and access credentials are created for consumer viners 102 and 110. The system then assigns a channel that is a viner's URL (Universal Resource Locator) home address to each viner depending on whether the viner is a consumer or a vendor.

An advantage of the present invention is that a channel is assigned to every viner, the channel conceptually representing the viner's world. A viner can use this home address to connect, transact, interact, and exchange ideas. Each viner has a unique channel—“V” channels are for vendors and “C” channels are for consumers. From their channel, a viner can control their profile, video player, video store or video library, vines directory, social apps, etc.

Once accounts are created and channels are assigned, vendor viner 104 may invite the registered social media participants. Specifically, video vender 104 invites consumer viner 102 and/or consumer viner 110 to become “friends” or “fans,” etc. of vendor viner 104.

Once the invitation from vendor viner 104 is accepted, consumer viners 102 and 110 become part of vendor viner 104's vine. Here, a vine is the network of “friends,” “fans,” or viners connected to the inviting viner. The invited viners mutually agree to be associated with or be friends with the inviting viner, allowing the invited viners to view the invitee's profile, follow each other's postings, receive new video content messages, etc. The invited viners may also have additional privileges such as the ability to request, preview and pay for content offered by vendor viner 104.

Here, specifically, consumer viner 102 and consumer viner 110 now belong to vendor viner 104's vine. Consumer viner 102 and consumer viner 110 can freely interact and exchange ideas with vendor viner 104. Consumer viners 102 and 110 are also notified when new video content is available from vendor viner 104. A further advantage of the present invention is that consumer viners 102 and 110 can preview and then rent or purchase video content for an automatically determined price in one embodiment.

In one embodiment, consumer viner 102 and/or consumer viner 110 can also preview and access video content from vendor viner 112 by requesting access to and joining vendor viner 112's vine. In an alternate embodiment, consumer viner 102 need not join vendor viner 112's vine to view, purchase or rent content where the transactional social media platform is primarily focused on growth of the vendor viner's consumer base.

Further, consumers (not shown) of existing social media platforms 114 and 116 may also be invited to preview, join the transactional platform and then purchase or rent video content from either vendor viner 104 or vendor viner 112. Further description of the use and operation of the present invention will be described with reference to the following drawings.

FIG. 1B illustrates a specific representation of transactional social media communication system 100 according to an exemplary embodiment of the present invention.

In FIG. 1B, transactional media communication system 100 comprises PublicVine 106 or transactional social media server system 106 of FIG. 1. The term PublicVine is coined by the present inventor for transactional social media server system 106.

PublicVine 106 is the central platform to which other system components are communicably coupled. Thus, social media platform 114, here Facebook™ 114 is communicably coupled to PublicVine 106. Social media platform or Twitter™ 116 is also communicably attached to PublicVine 106. Consumer viners 102 and 110 are further coupled to PublicVine 106. And vendor viners 104 and 112 are integrated with PublicVine 106.

PublicVine 106 facilitates transactions between the communicably coupled participants. Specifically, PublicVine 106 enables vendors of music videos, reality shows and feature movies to use PublicVine's network as well as existing social networks such as Twitter™ 116 and Facebook™ 114 to market and monetize their video content worldwide.

Thus, users such as consumer viner 102 and consumer viner 110 can watch premium music videos, reality shows and feature movies provided by vendor viner 104 and vendor viner 112. PublicVine 106 facilitates these transactions and in one embodiment determines an applicable price for transactions. Consumer viners 102 and 110 may also interact with vendor viners 104 and 112, exchange ideas, chat and initiate and execute various apps (e.g., games) and the like.

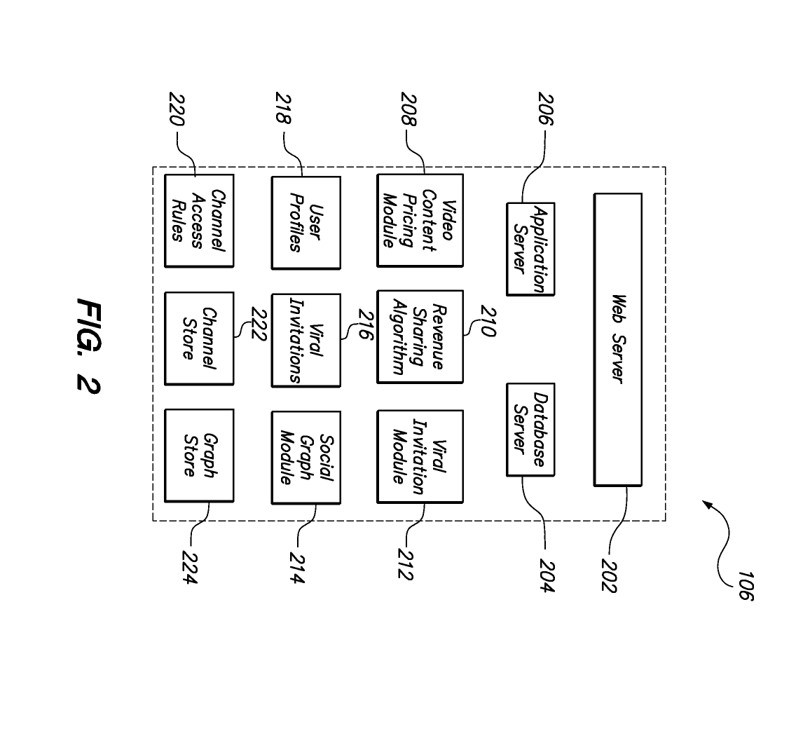

FIG. 2 illustrates components of transactional social media server system 106 according to an exemplary embodiment of the present invention.

In FIG. 2, among other components, transactional social media server system 106 includes web server 202 as well as application server 206. Web server 202 is as described with reference to web server 106A (FIG. 1A). As previously noted, web server 202 may host a website through which consumer viner 102 (FIG. 1) can serve HTTP/webpage requests on web server 202.

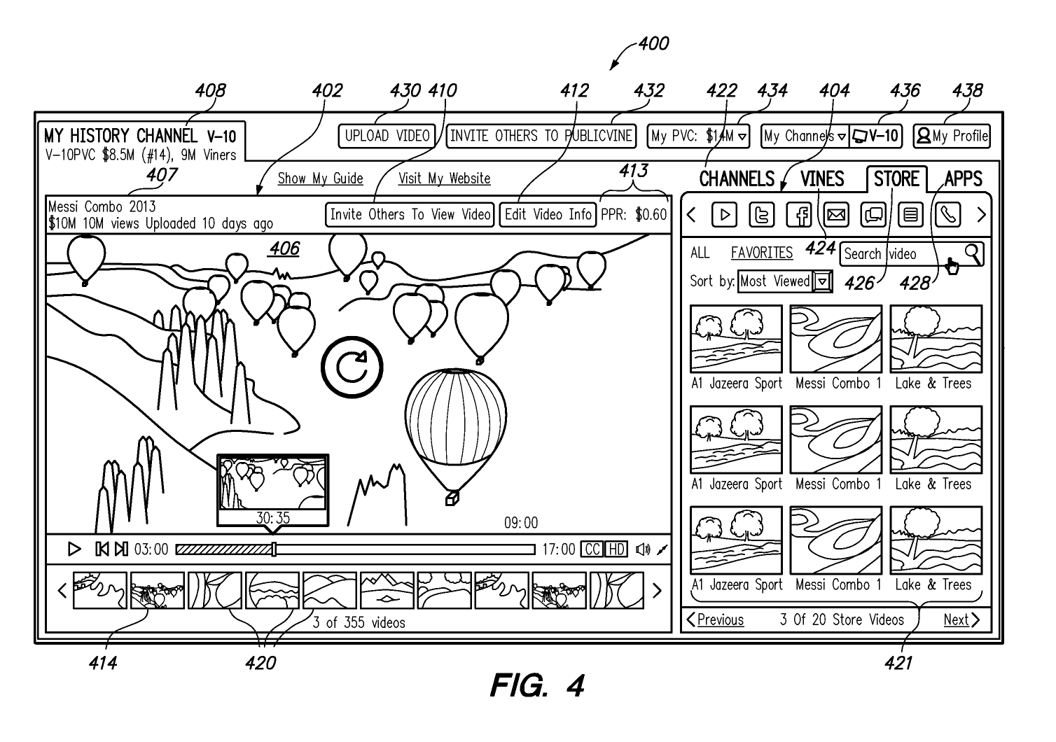

Web server 202 responds to such webpage requests, and in conjunction with application server 206 and database server 204, can facilitate transactions requested by consumer viner 102 such as a request to view video content and/or chat or exchange information with other consumer viners. Examples of the requested webpage interfaces are described below with reference to FIG. 4 and subsequent figures. An example of a web server suitable for use with the present invention would be Apache™ that uses PhP and CGI.

Application server 206 can manage capabilities such as load balancing, etc. as well as support business back end capabilities of the present invention such as video content pricing, revenue sharing, social graph analysis, and viral invitations to vendor viners and consumer viners including using APIs (Application Programming Interfaces (not shown)) to communicate with external contacts or access existing social networking platforms such as Facebook™.

An example of application server 206 that is suitable for the present invention is Oracle's WebLogic server in an EJB (Enterprise Java Beans) provided environment. These are but examples, and one skilled in the art will realize that other suitable software and/or hardware can be utilized with the present invention.

Database server 204 processes and manages data for storage and retrieval on user profiles database 218, viral invitations database 216, channel access rules database 220, channel store database 222 and graph store database 224. Any suitable database consistent with the principles and precepts of the present invention may be utilized.

In FIG. 2, transactional social media server system 106 may also include video content pricing module 208, revenue-sharing algorithm 210, viral invitation module 212 and social graph module 214, all of which, although shown separately, may be incorporated with application server 206.

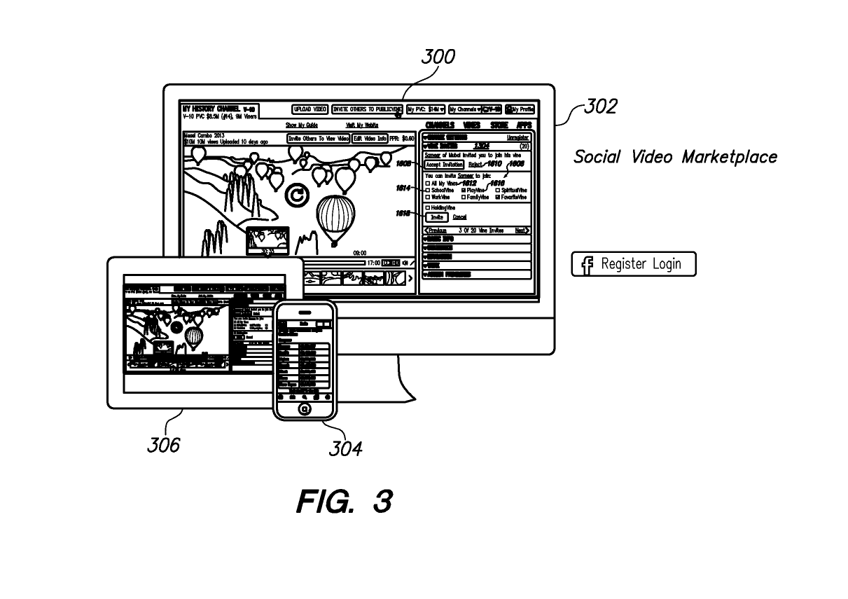

FIG. 3 illustrates a transactional social media interface 300 according to an exemplary embodiment of the present invention.

In FIG. 3, transactional social media interface 300 is depicted on desktop display 302, mobile display 304 and tablet display 306. Elements and features of transactional social media interface 300 will be described with reference to FIG. 4 and subsequent figures.

FIG. 4 illustrates vendor viner store interface 400 according to an exemplary embodiment of the present invention.

In FIG. 4, vendor viner 104, having uploaded a plurality of video content items, may employ vendor viner store interface 400 to list, view and access each video content item as necessary. One skilled in the art will recognize that vendor viner store interface 400 as well other webpage interfaces described with reference to figures below are exemplary and may be implemented in a plurality of different ways.

As shown, vendor viner store interface 400 includes two main sections namely video display area 402 and information display area 404. Video display area 402 outputs video content from a video player, displaying said video content over a substantial area of the screen. Here, the currently playing video content 406 is “Messi Combo 2013” as shown by title display 407. “Messi Combo 2013” is one of a plurality of video content items uploaded by vendor viner 104, who is assigned channel symbol “V-10” and named “HISTORY CHANNEL” as shown by channel title display 408.

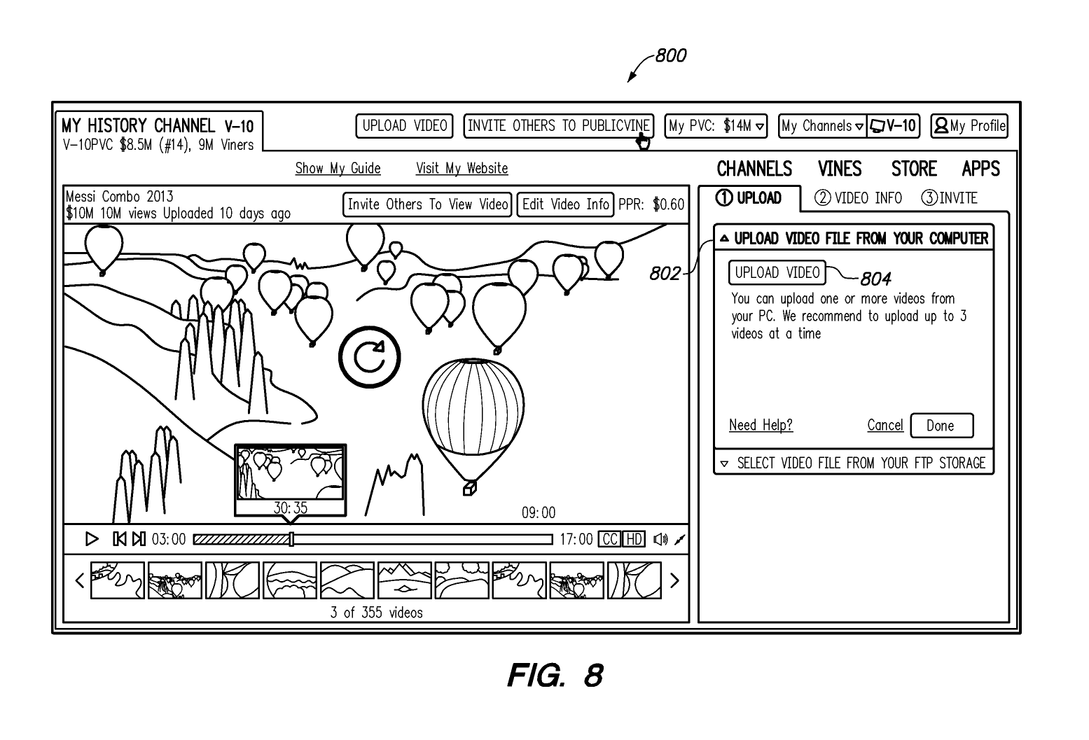

Video display area 402 also includes button 410 and button 412 for respectively inviting others to view video content and for editing video information. (Selection of button 412 also displays video content label interface 900 of FIG. 9). Video display area 402 also includes a play button and progress indicator 414 and a plurality of mini video display windows 420.

In FIG. 4, information display area 404 comprises a plurality of thumbnails 421 representing video content available for rent or purchase from vendor viner 104. Information display area 404 includes at least four selectable tabs, namely channels 422, vines 424, store 426 and apps 428.

Vendor viner 104 selects channels 422 to display all of the channels available to vendor viner 104. A channel is a viner's home address from where vendor viner 104 can connect and initiate video content transactions. In the present embodiment, each viner has a unique channel—“V” channels are for vendors and “C” channels are for consumers. From their channel, a viner can control their profile, video player, video store or video library, vines directory, social apps, etc. Here, vendor viner's designated channel is V-10 as shown at 408.

Vendor viner 104 may select vines 424 to display his or her vines that are stratified into multiple categories or groups of viners as will be further discussed. As an example, viners may be stratified into spiritualvines comprising viner's associated with vendor viner 104's church.

Similarly, vendor viner 104 may display the vendor's store by selecting store 426 as shown here, which then displays a plurality of thumbnails 421 associated with video content stored in channel V-10. Vendor viner 104 may also display apps by selecting apps 428 to display or initiate any number of apps including chat, email, etc.

Vendor viner store interface 400 also includes various buttons along the upper periphery of the screen, the buttons including “Invite Others to View Video” 410 for inviting users to view an uploaded video, edit video 412 for editing information and meta data associated with video content, upload video 430 for uploading video content to channel V-10, invite others to public vine 432 for inviting others to the transactional social media platform, PVC button 434 that shows the amount of credit in the vendor's account, channel display button 436 that displays the vendor's current channel and my profile button 438 that can be used to view and edit the vendor's profile.

An advantage of the present invention is that vendor viner store interface 400 also includes price per rent display 413, which here indicates that the price for renting video content 406 is $0.60. One of ordinary skill in the art will realize that vendor viner store interface 400 is just an exemplary embodiment and other implementations consistent with the spirit and scope of the present invention are possible.

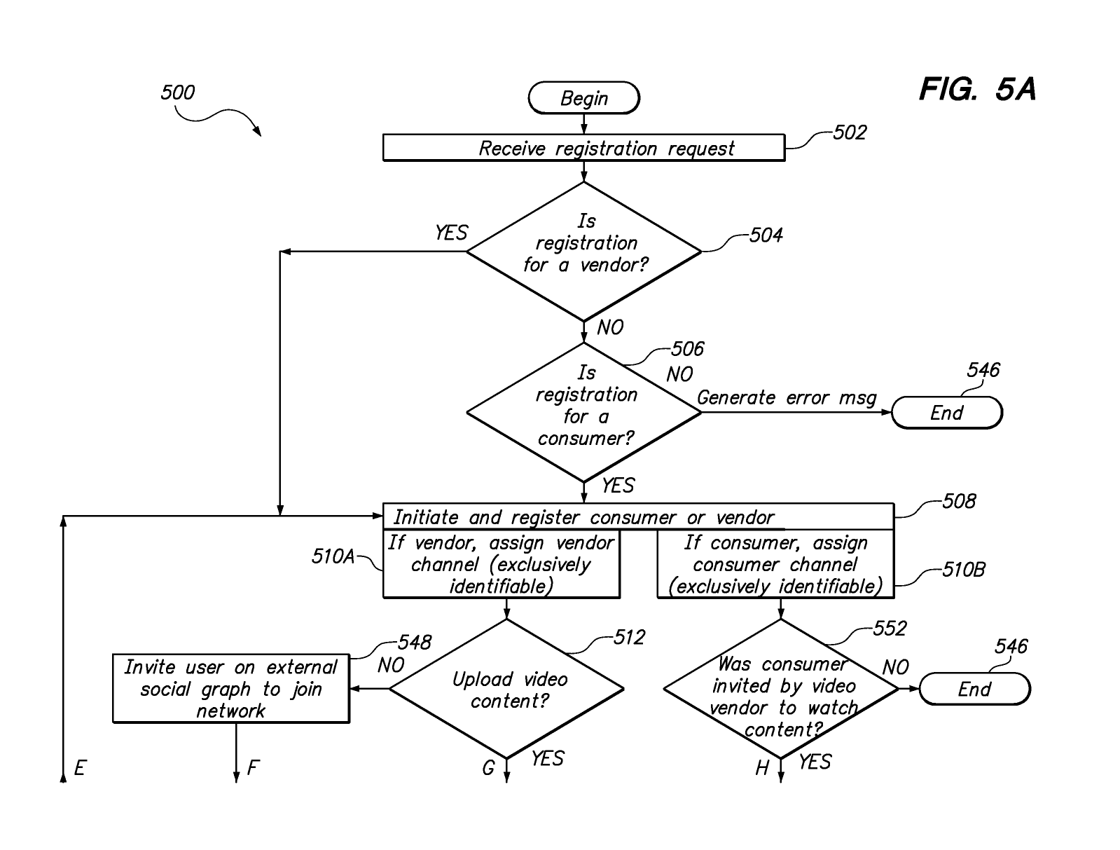

FIG. 5 illustrates registration method 500 according to an exemplary embodiment of the present intention.

In FIG. 5, registration method 500 illustrates the process by which prospective or current viners including any one of consumer viners 102, 110 or vendor viners 104, 112 were registered as viners by transactional social media server system 106 (FIG. 1). Registered viners may then obtain an exclusively assigned channel and if permitted, upload video content for transactional purposes.

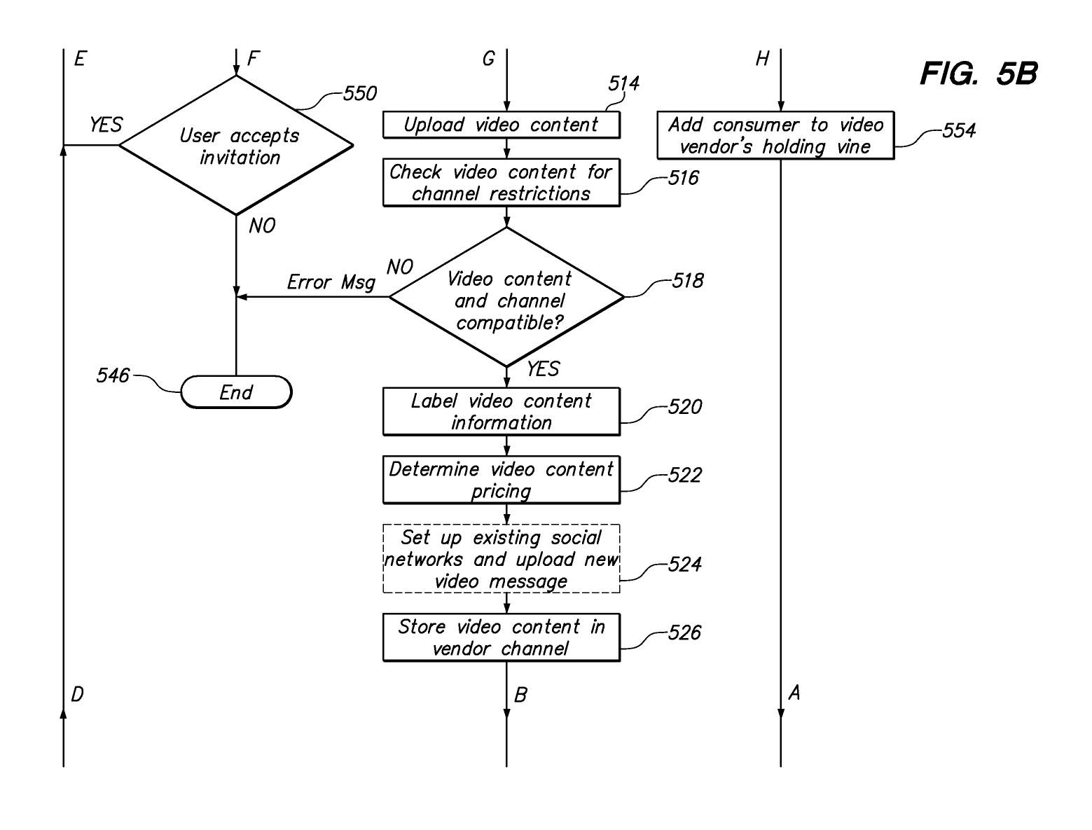

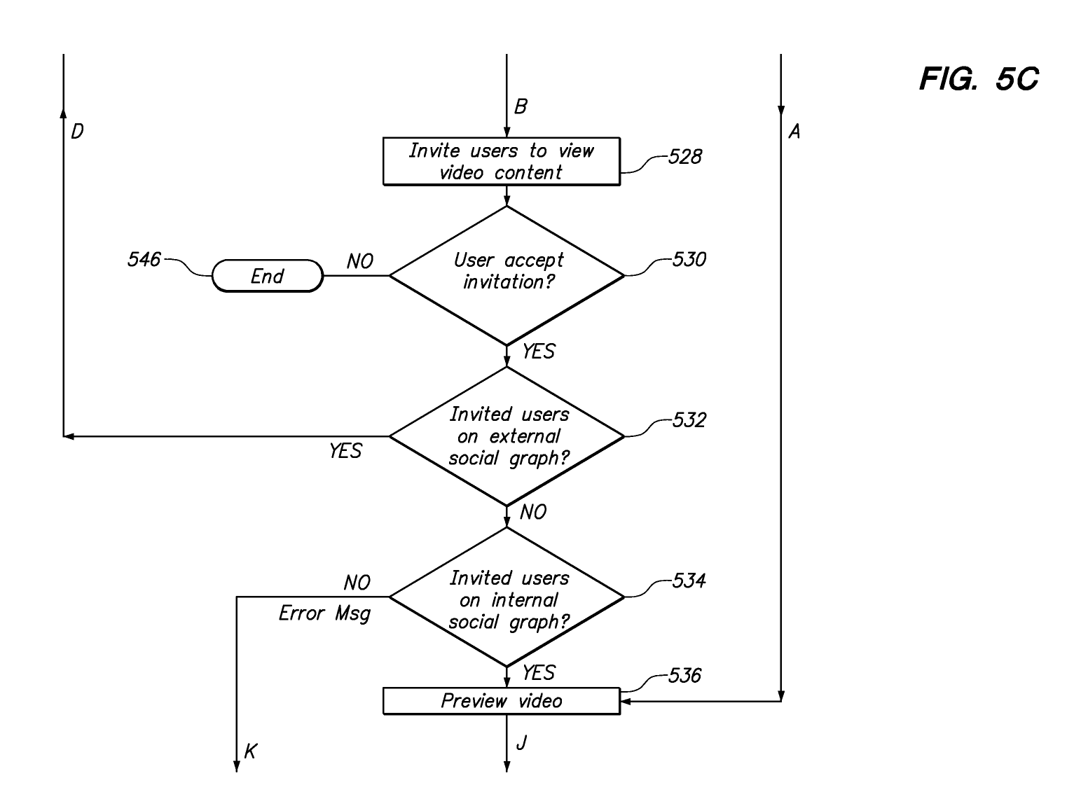

At block 502, transactional social media server system 106 receives a registration request from a prospective viner. The registration request may be sent by a computing device (not shown) associated with the prospective viner. Responsive thereof, web server 202 (FIG. 2) sends registration form 600A (FIG. 6A) to the prospective viner.

At decision block 504, it is determined whether the registration request is for a vendor. In one embodiment, this determination is based on which selection is made by the prospective viner on registration form 600A of FIG. 6A. In an alternate embodiment, the determination may be based on system evaluation of the prospective viner, which may for example, be based on publicly available information or records about the prospective viner.

If a vendor, the prospective viner selects vendor button 602 to indicate that he or she is a vendor. Upon selection, the appropriate fields 604 corresponding to vendor button 602 are displayed. Non-corresponding buttons are grayed out.

Here, the prospective viner can indicate a commercial name in field 606, indicate the number of video titles to be uploaded in video upload field 605, indicate its tax ID in field 608, register date in field 610 and may upload the certificate of incorporation by selecting button 612.

The prospective viner may also indicate whether or not he or she is a company or an individual by selecting link 603A or 603B. The prospective viner can also use drop down menus and fields 614 to indicate the responsible person. Once registration form 600A is completed, the prospective viner selects the register button 616 to submit registration form 600A to web server 202 (FIG. 2).

At block 508, registration method 500 then registers the prospective viner as a vendor (i.e. vendor viner 104). Typically, application server 206 (FIG. 2) and database server 204 (FIG. 2) process registration from 600 and create a user profile for storage in user profile's database 218 (FIG. 2). Among other information, the user profile may include a unique user identifier, company name, tax ID, responsible person, location, attributes and the like. After registration, the process proceeds to block 510A.

Returning to decision block 504, if registration is not for a vendor, the method proceeds to decision block 506.

At decision block 506, method 500 determines whether registration is for a consumer based on registration form 600B of FIG. 6B.

FIG. 6B illustrates registration form 600B for a consumer according to an exemplary embodiment of the present invention.

In FIG. 6B, if a consumer—the prospective viner—receives this registration form 600B and selects consumer button 620 that indicates to transactional social media server system 106 that the prospective viner is a consumer, the prospective viner then uses drop-down button 622 to select a country, mobile number field 624 to enter a mobile number, email field 626 to indicate an email address, name fields 628 to enter a first and last name, and drop-down buttons 630 to enter a birth date.

Upon completion of all of the information, the prospective viner selects register button 632 to submit all of the information to web server 202 to complete registration. Note here that unlike registration form 600A that includes video upload field 605 for entering the number of videos for upload, registration form 600B has no such indication as consumers are not permitted to upload video content under the present system.

At block 508 (FIG. 5), web server 202 receives registration from 600B from the prospective consumer viner, and thereafter application server 206 in conjunction with database server 204 uses the information to create an account and credentials for the consumer viner (e.g., 102) for storage in user profile's database 218. After an account is created for consumer viner 102, the process proceeds to block 510B.

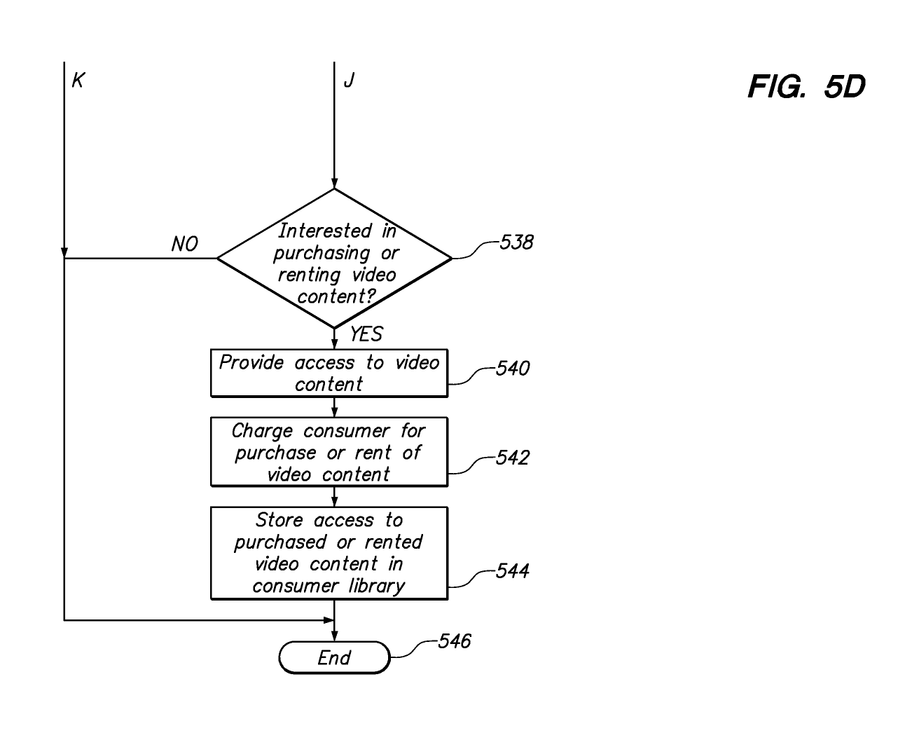

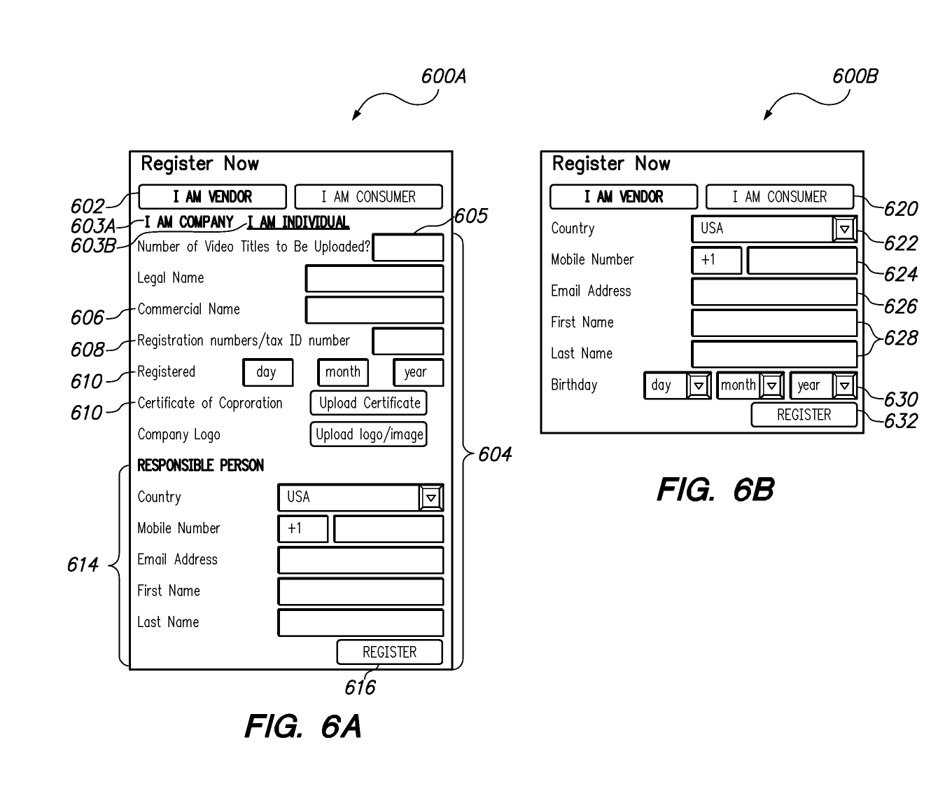

In FIG. 5, referring now to block 510A, after registration of vendor viner 104, transactional social media server 106 assigns a vendor channel with an exclusive identifier to vendor viner 104 as shown in FIG. 7A.

FIG. 7A illustrates vendor viner channel form 700A according to an exemplary embodiment of the present invention.

In FIG. 7A, vendor viner channel form 700A is transmitted to vendor viner 104 after a channel is assigned. As shown, the identifier that is assigned to vendor viner 104 is “Vendor-22.” As used here, conceptually, a channel is the entirety of the user's world. It contains all of the video content, apps, or any other pertinent information that the vendor might have.

The vendor channel is a user's home address that aggregates all of the files and content uploaded by the vendor. Unlike conventional systems that store their content in disparate locations and do not have a specific channel with which vendor viners can be associated, the present invention assigns an exclusively identifiable identifier to a vendor viner and stores all of the vendor viner's content in one single location. This makes it effortless to search for and identify the vendor as well as to observe a listing of all the content in the vendor viner's account.

The present invention is flexible as vendor viner 104 or 112 may use channel name field 704 of vendor viner channel form 700A to enter his or her own channel identifier. Vendor viner 104 may also use drop-down button 706 to select a channel group. Channels that have similar subject matter may be grouped in the same category. Vendor viner 104 may also use drop-down button 708 to select sub-channel groups.

Another advantage of the present invention is that it uses a rating system to manage channels as well as video content. Drop-down button 710 can be employed to assign a particular rating to a video channel. In particular, in one embodiment, various ratings include G—subject matter that is appropriate for a general audience; PG (Parental Guidance) or R (Restricted), and these can be assigned to a channel. In this manner, mature content such as pornographic materials or other content inappropriate for children can be restricted to the appropriate channels.

Once all of this information is entered, vendor viner 104 than selects create button 712 to transmit vendor viner channel form 700A to transactional social media server system 106. Responsive thereof, application server 206 (FIG. 2) of the transactional social media server system 106 in conjunction with database server 204 then creates vendor channel “Vendor-22” and stores the channel access rules (ratings, etc.) in channel access rules database 220. Note that the channel home address and video content stored therein are stored in channel store 216. The process then proceeds to decision block 512.

Referring now to block 510B, after transactional social media server 106 has registered consumer viner 102, the system next assigns a consumer channel to consumer viner 102, sending consumer channel form 700B (FIG. 7B) to consumer viner 102.

FIG. 7B illustrates consumer channel form 700B according to an exemplary environment of the present invention.

In FIG. 7B, consumer channel form 700B is received by consumer viner 102 after channel creation. As can be observed, message 720 displays, “Your channel is Consumer-21” and message 721 states, “Your channel's system name will be /-C21.” Consumer viner 102 can use channel name field 722 to enter a channel name, enter a website URL at 724, upload a logo image at 726 and enter pertinent channel rating information at 728. After entering all of the requisite information, consumer viner 102 selects create button 730 to create consumer channel “Consumer-21.”

Referring now to block 510A, after a vendor viner channel is created for vendor viner 104, the method proceeds to decision block 512.

At decision block 512, it is determined whether vendor viner 104 wishes to upload video content. Without limitation, video content may include commercially viable music videos, documentaries, game shows, reality shows, feature films, instructional videos and other like content. If vendor viner 104 wishes to upload video content, the method proceeds to block 514.

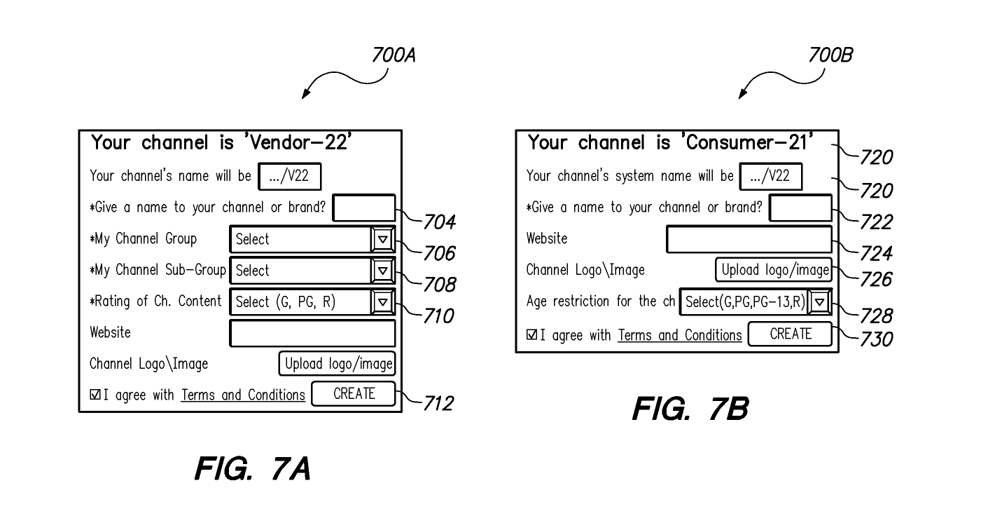

At block 514, vendor viner 104 uploads video content using upload video interface 800 of FIG. 8.

FIG. 8 illustrates video upload interface 800 according to an exemplary embodiment of the present invention.

Specifically, in FIG. 8, web server 202 displays video upload interface 800 that enables video content to be uploaded from vendor viner 104 to transactional social media server system 106. As shown, vendor viner 104 can select drop-down button 802 to “UPLOAD VIDEO FILE FROM YOUR DEVICE.” Upon selection of drop-down button 802 and selection of appropriate files from the vendor viner's computer, vendor viner 104 can than select the upload video button 804 to initiate upload of the video content.

At block 516, after video content is uploaded, it is checked for channel restrictions. That is, the video content is compared to the channel ratings to determine compatibility.

In one embodiment, indicating the rating of the content is compared to the channel rating to determine if the video content is allowed. As an example, if the channel rating of Vendor-22 is PG, video content with an R rating cannot be uploaded. In an alternate embodiment, the video content may be uploaded and monitored by users. Users can flag and report inappropriate content, which may then thereafter be disabled for viewing.

In another embodiment, the video content rating is not compared to the channel rating. The video content is uploaded but the channel ratings for different channels are compared to determine compatibility between channels. For example, a channel rated M (mature) cannot show up on the channel listings for a channel rated PG, for example.

At decision block 518, if the video content and the channel ratings are compatible, the method proceeds to block 520.

At block 520, the method allows vendor viner 104 to use video content label interface 900 of FIG. 9. This interface includes various fields generally indicated as 902 that can be utilized to label uploaded video content.

Vendor viner 104 can enter a director label, producer label, actors, the budget, a tag and a description of video content. Vendor viner 104 can also use drop-down button 904 to set thumbnails and drop-down button 906 to create previews. Upon completing video content label interface 900, vendor viner 104 selects done button 908 to transmit video content label interface 900 to web server 202.

At block 522, a pricing for the uploaded video content is determined. An advantage of one embodiment of the present invention is that pricing is automatically determined by video content pricing module 208 (FIG. 2) in conjunction with application server 206 (FIG. 2) of transactional social media server system 106.

Auto Video Content Pricing:

Pricing module 208 uses an algorithm that determines the price that video content will be sold for by using the following equation:

PF=MPF*BC (1)

where PF is the Price Floor; MPF is a Multiple of the Price Floor that is a constant, preferably 5; and BC is the Base Cost according to the following equation:

$$B C = {c}_{b} max \{ {s}_{e 1} , … , {s}_{e \vert E \vert} \} + \frac{{c}_{s} ( {s}_{u} + {Σ}_{v ∈ E} {s}_{v} )}{S P S} + \frac{{d}_{u} ( {c}_{e} \vert S \vert + {c}_{h} \vert H \vert )}{S P E} \qquad ( 2 )$$

where:
c_{b} is the cost of bandwidth per megabyte;
max{sₑ₁, . . . , s_{e|E|}} size (largest encoded video);
cₛ is the cost of monthly storage per megabyte;
sᵤ is the size of uploaded video;
v is the generic video variable;
E is the set of all encoded videos;
sᵥ is video size;
SPS is a constant=10, the number of monthly views over which to spread monthly
   storage cost;
du is duration of uploaded video rounded to the nearest minute;
cₑ is the cost of standard definition encoding per min;
   |S| is the quantity of all SD encoded videos;
cₕ is the cost of HD encoding per min;
   |H| is the quantity of all HD encoded videos;
SPE is a constant −100, number of monthly views over which to spread one-time encoding cost

Here, the term: c_{b}max{sₑ₁, . . . , s_{e|E|}} in equation 1 is the bandwidth cost, BA.

The term

$$\frac{{c}_{s} ( {s}_{u} + {Σ}_{v ∈ E} {s}_{v} )}{S P S}$$

in equation 1 represents storage, S, the cost of monthly storage per MB multiplied by the size of uploaded video+cumulative sum of size of encoded videos all divided by the spread.

The term

$$\frac{{d}_{u} ( {c}_{e} \vert S \vert + {c}_{h} \vert H \vert )}{S P E}$$

in equation 1 represents E encoding cost is given by: (duration of the uploaded video*(cost of standard definition encoding per second*standard definition count+cost of high definition encoding per second*high definition count))/number of monthly views over which to spread encoding cost.

However, vendor viner 104 need not utilize the automatic pricing that's determined by the system. The vendor viner 104 may manually set a different pricing level, either below or above the automatically determined price of the video content. If the automatically determined pricing of the video content is not used, the amount of revenue received by all revenue sharing participants is altered. As we will further described in co-pending patent application filed concurrently herewith the present invention includes a revenue sharing algorithm implemented by revenue sharing algorithm 210 (FIG. 2) of transactional social media server system 106.

Briefly, revenue sharing algorithm 210 shares the revenue obtained by sales of video content from each sale of video content amongst various participants including the video content owner, the transactional social media platform, the user that referred the vendor to join the network and the user that referred the consumer that purchased the video content. After the video content pricing is determined, the process proceeds to block 524.

At block 524, in one embodiment, as an alternative, vendor viner 104 may set up existing social networks and thereafter upload a new video message to the walls of such existing social networks. As an example, if vendor viner 104 has a Facebook™ account, vendor viner 104 may typing a message to his Facebook™ wall stating that new video content has been uploaded by vendor viner 104 to vendor channel V22.

At block 526, the video content is stored on vendor channel vendor-22. Thereafter the process proceeds to block 528.

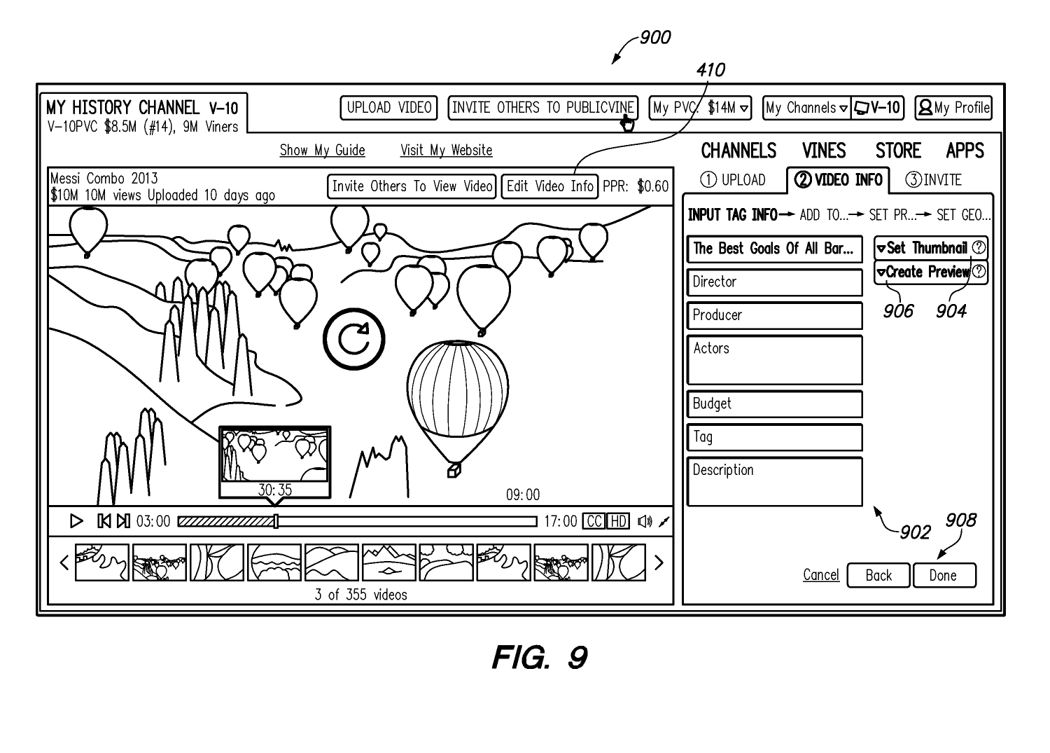

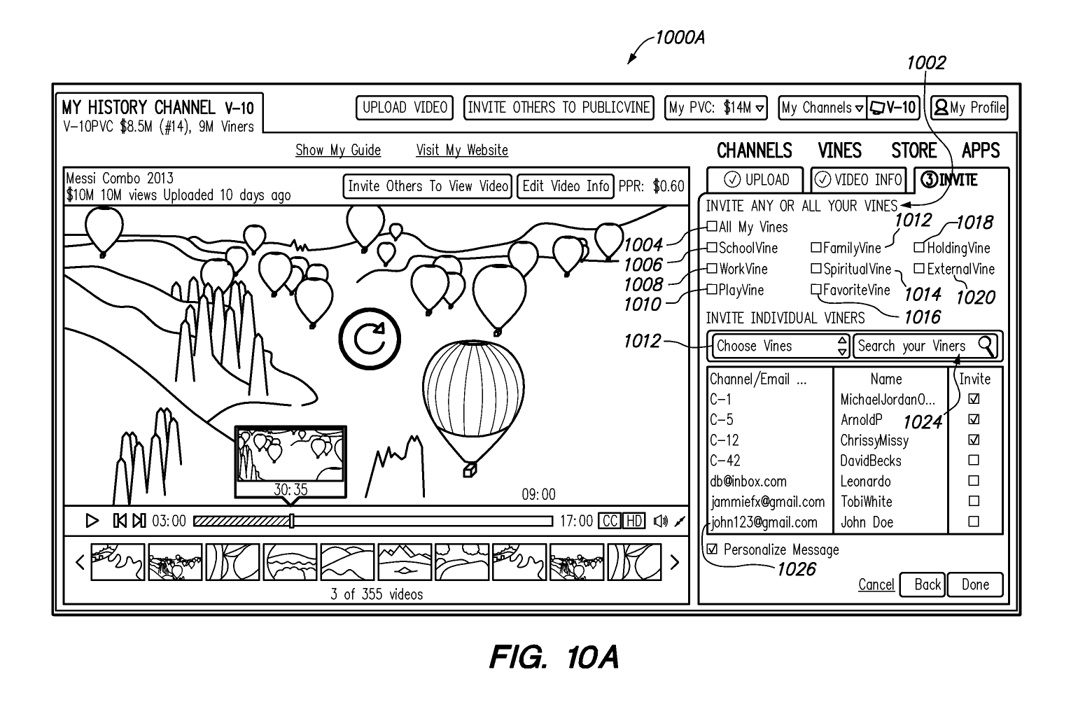

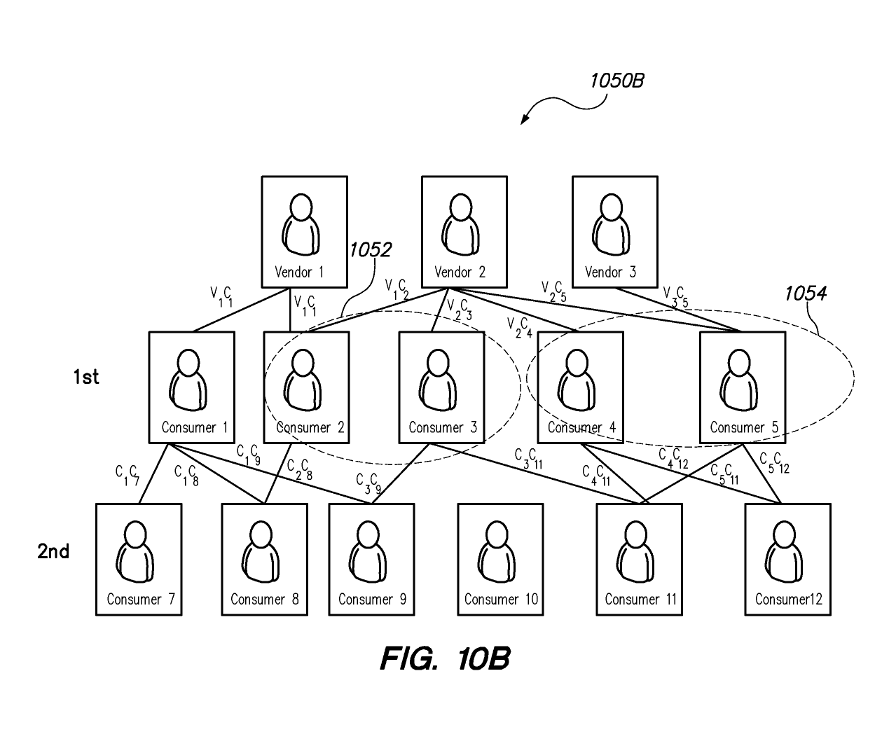

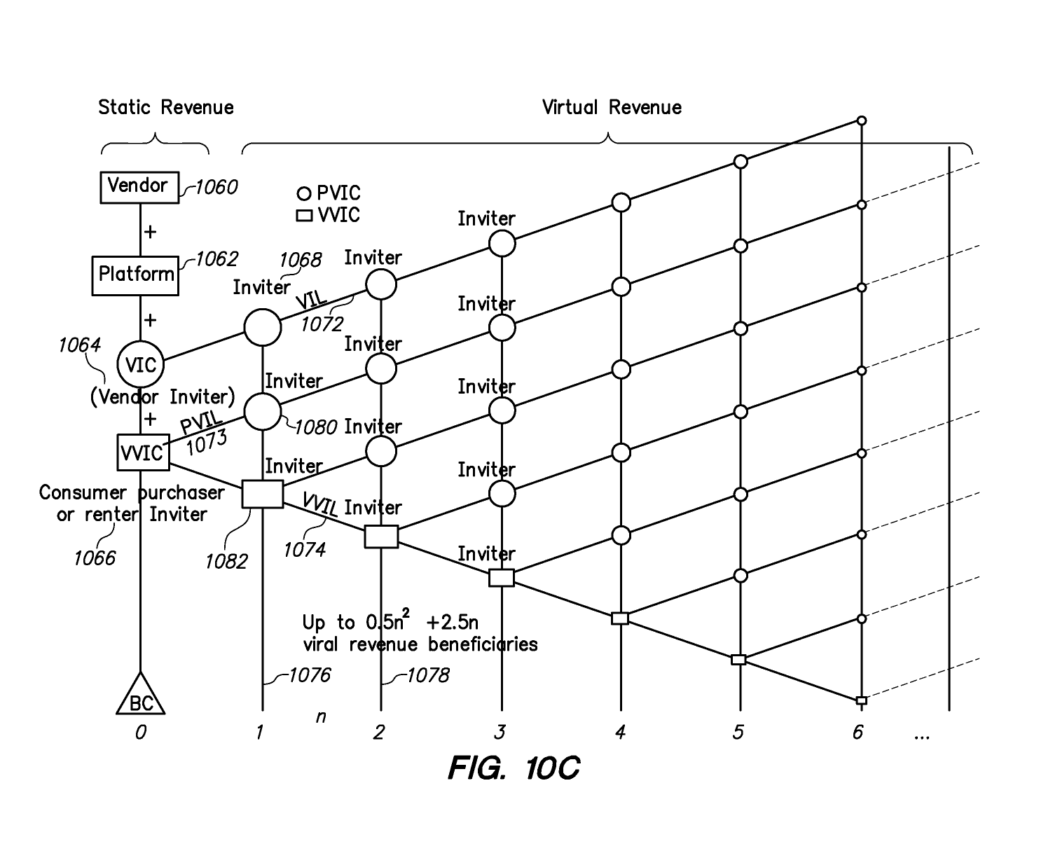

At block 528, vendor viner 104 may then invite viewers to view the new uploaded video content. To facilitate invitation of viewers, transactional social media server system and specifically web server 202 transmits content view invite interface 1000A of FIG. 10A to prospective consumers.

FIG. 10A illustrates content view invite interface 1000A according to an exemplary embodiment of the present invention.

In FIG. 10A, vendor viner 104 may employ content-view invite interface 100 to invite viners or prospective viners to view video content. Here, content-view invite interface 1000A includes invite section 1002 titled “INVITE ANY OR ALL OF YOUR VINES.” Conceptually, as noted elsewhere in this disclosure, the term vine can be analogized to a tree vine having stems stratified or compartmentalized but that also remains flexible for continuous growth in different directions.

The term vine refers to all of the users contacts, social network, friends, fans, all the like, whether or not those users are internal or external to the transactional social media platform. An advantage of the present invention is that a user's vine or social graph can be stratified or compartmentalized into categories as shown.

Unlike conventional social networking systems that lumps all of the user's social graph or contacts into a single category of friendship, the present invention stratifies the social graph or contacts into multiple categories or sections of friends. Specifically, the present invention includes a schoolvine and a familyvine group of friends. The schoolvine includes all friends that are associated with the user's school. The familyvine includes family or family members including immediate and extended family members for example.

Herein is an immediate advantage of the present invention. Since friends that are associated with a user's school may not necessarily and in fact oftentimes are not family members, the present application stratifies those two groups and keeps contact and message between those two groups, or interactions between those two groups separate.

The transactional social media platform of the present invention also includes a workvine and a spiritual vine. The workvine includes all friends that are associated with the user's work, while the spiritual vine includes all friends that are spiritually associated with the user, including faith members, agnostic members, etc. The transactional social media platform also includes a play vine and a favorite vine. The play vine includes contacts that are associated with a person's social activity while a favorite vine includes any and all contacts that are a favorite of the user.

Another advantage of the present invention is that it includes an external vine and a holdingvine. An external vine is the category of users or contacts that are outside of the transactional social media platform such as contacts and friends that may be on Facebook, Twitter, Google, or even email.

A holdingvine is a transitional category that is intended to hold contacts and friends from an external network before they are categorized into any one of the internal vines namely the schoolvine, workvine, play vine, familyvine, spiritual vine, and the favorite vine.

In FIG. 10A, as can be seen, vendor viner 104 may choose to invite all vines by selecting checkbox 1004; invite schoolvine contacts by selecting checkbox 1006; checkbox 1008 to invite his or her workvine; checkbox 1010 to invite his or her playvine; checkbox 1012 to invite the familyvine; checkbox 1014 to invite the spiritualvine; checkbox 1016 to invite favoritevine contacts; checkbox 1018 to invite the holdingvine contacts; and checkbox 1020 to invite externalvine contacts or friends.

Note that initially, a newly registered viner may have no contacts or friends internally and so there would be no vines or friends within schoolvine, workvine, play vine, familyvine, spiritual vine and the favorite vine. In such a case, the viner would invite the external vine after which those external contacts that accept an invitation into the network are stored into the holdingvine.

Here, vendor viner 104 has selected checkbox 1020 to invite externalvine contacts. Vendor viner 104 may also select individual viners from all of the vines. By selecting drop down button 1022 and then entering a contact name search field 1024 to search the selected vine. Note that external vines also include email contacts as well. For example an email contact may be john123@gmail.com with the name John Doe as shown at 1026. After users have been invited to view the video content, the process proceeds to decision box 530.

At decision box 530, if the invited users do not accept the invitation to view the video content, the process is terminated at end block 546.

If one or more users accept the invitation to view video content, the process proceeds to decision block 532.

At decision block 532 it is determined whether the invited users are on an external social graph. That is, whether or not the invited users are external contacts who are not currently on the transactional social media platform.

If the invited users are on an external social graph, the process returns to block 508, where the invited users are registered and allocated channels within the transactional social media platform. In one embodiment, no registration is required, and invited users may access video content so long as they provide an acceptable payment method for which they can be charged for viewing such video content.

In another embodiment, all users and/or viners (both external and internal) must be registered viners on a vendor's vine or social graph in order for the user to access video content from that video viner. Thus, the transactional social media platform determines tracks and checks a viner's social graph when a consumer request for video content access is requested as further described with reference to FIG. 10B.

FIG. 10B illustrates social graph 1050A according to an exemplary embodiment of the present invention.

In FIG. 10B, social graph 1050B shows a representation of viner relationships on the transactional social media platform. Specifically, here, the viner relationships that are established and represented are those between vendor and consumer viners. Vendor viners may upload and grant access to the content. Consumer viners or accounts are configured so that they cannot upload video content. Consumer viner requests to upload video content are denied.

As shown, on social graph 1050B, each vendor viner and consumer viner is a node. For example, vendor 1, vendor 2 and consumer 1, consumer 4 are all nodes. A multiplicity of edges connects the nodes. For example, V₁C₁ is an edge connecting vendor 1 and consumer 1. Edge C₃C₁ connects consumer 3 and consumer 11.

Each connection between two nodes represents a relationship between the two nodes. Each connection also establishes a degree of separation between the two nodes. A degree of separation can be 1^{st} degree, where a direct connection exists between two viners, that is, where two viners are direct friends; or it might be 2^{nd} degree where two viners are separated by a node, where the two viners are friends indirectly via a direct friend, etc. Thus, for example, vendor 1 and consumer 2 are separated by a 1^{st} degree or connection edge V₁C₁ while vendor 1 and consumer 8 are separated by a 2^{nd} degree or two edges V₁C₂ C₂C₈.

The degree of separation and number of connections can vary. The 1st degree connections for example, between vendor viners and consumer viners may be multiple or single connections. Thus, vendor 1 and consumer 1 are connected via edge V₁C₁ to and vendor 1 and consumer 2 are also linked via edge V₁C₂. Vendor 2 and consumers 2, 3, 4, and 5 are respectively linked via V₂C₂, V₂C₃, V₂C₄ and V₂C₅ to consumer 5. Vendor 3 has only a single connection to consumer 5 via V₃C₅.

The 2^{nd} degree connections between consumers may also vary from single to multiple connections. Consumer 1 is connected to consumers 7, 8 and 9 via edges C₁C₇ and C₁C₈ and C₁C₉ respectively. Whereas, consumer 2 is only connected to consumer 8 via edge C₂C₈. All of the aforementioned consumer connections represent a second degree of separation from vendor 1. The higher the number of connections linking a vendor viner to consumer viners, the higher the revenue potential for the vendor viner. Note that consumers can make revenue based on their connections to other consumers who make commission.

Social graph 1050B is managed by social graph module 214 (FIG. 2), which stores an adjacency or matrix list of adjacent relationships in graph store database 224 (FIG. 2). When application server 206 (via web server 202) receives a request from a video viner, for example, application server 206 queries social graph module 214, for a list of viners that are adjacent and the separation degree between the viners.

In one embodiment, the adjacency list is then used to determine consumer viners that will receive invitations to view new video content uploaded by the video viner. In an alternate embodiment, the adjacency list of relationships may be generated based on a request from a consumer to purchase (or rent) video content purchase from a consumer.

Thus, in one embodiment, the list may be employed to determine whether a consumer viner may access video content. Thus, if it is required that the degree of separation between a consumer and vendor viner must be 1^{st} degree for the consumer viner to access content, in FIG. 10B, when vendor 1 offers video content, the content can be accessed only by consumers 1 and 2 because they have a direct relationship; consumers 7, 8 and 9 may not access the video content because they are 2^{nd} degree.

If a connection must exist between a consumer and a vendor viner for the consumer viner to access content, consumers 1, 2, 7, 8, and 2 that are connected to vendor 1 can access content from vendor 1 while consumer 10 may not do so because there is no connection between and consumer 10 and vendor 1. Yet, in a further embodiment, any consumer viner on the online social network may access content from any vendor.

In FIG. 10B, note also that consumers may be stratified into different social groups. For example, although vendor 2 has a connection with consumers 2, 3, 4 and 5, vendor 2, consumer 2 and 3 are stratified into workvine group 1052; while vendor 2 and consumers 4 and 5 are in a separate playvine group 2054.

Consumers that are connected to vendors may also be external to the transactional social media platform. For example, consumer 9 may be a member of a traditional social networking platform such as Facebook™. Thus, consumer 9 on Facebook™ may be connected via edge C191 to consumer 1, who is a viner on the transactional social media platform.

Returning to decision block 532, if the invited users are not an external social graph, the process proceeds to decision block 534.

At decision block 534, it is determined whether the invited users are on vendor viner 104's internal social graph, that is, whether or not invited users are viners. If invited users are not in the transactional social platform, an error message is generated and the process terminates at end block 546 since all users must be either internal or external. If the invited users are viners within the internal social graph, the process proceeds to block 536.

At block 536, the invited viners may preview the video content. Note however, that in one embodiment, viners may not preview video content if their channel ratings are incompatible with the ratings of their own channel or rating of the video content. After the video content is previewed at block 536, the process proceeds to decision block 538.

At decision block 538, it is determined whether the invited viners wish to purchase the previewed video content. If the viners do not wish to purchase video content, the process proceeds to end block 546 where the process is terminated. If the invited viners wish to purchase video content the process proceeds to block 540.

At block 540, the users are provided with access to the video content. Users may not receive access to video content if their assigned channel is incompatible with the rating of the video content channel.

At block 542, the user is charged for purchase or rent of the video content. Herein is another advantage of the present invention. Unlike existing social networks where there are no video content transactions, the present invention facilitates transactions that offer or rent video content and provides an automatic mechanism for determining pricing and charging the consumer for such video content.

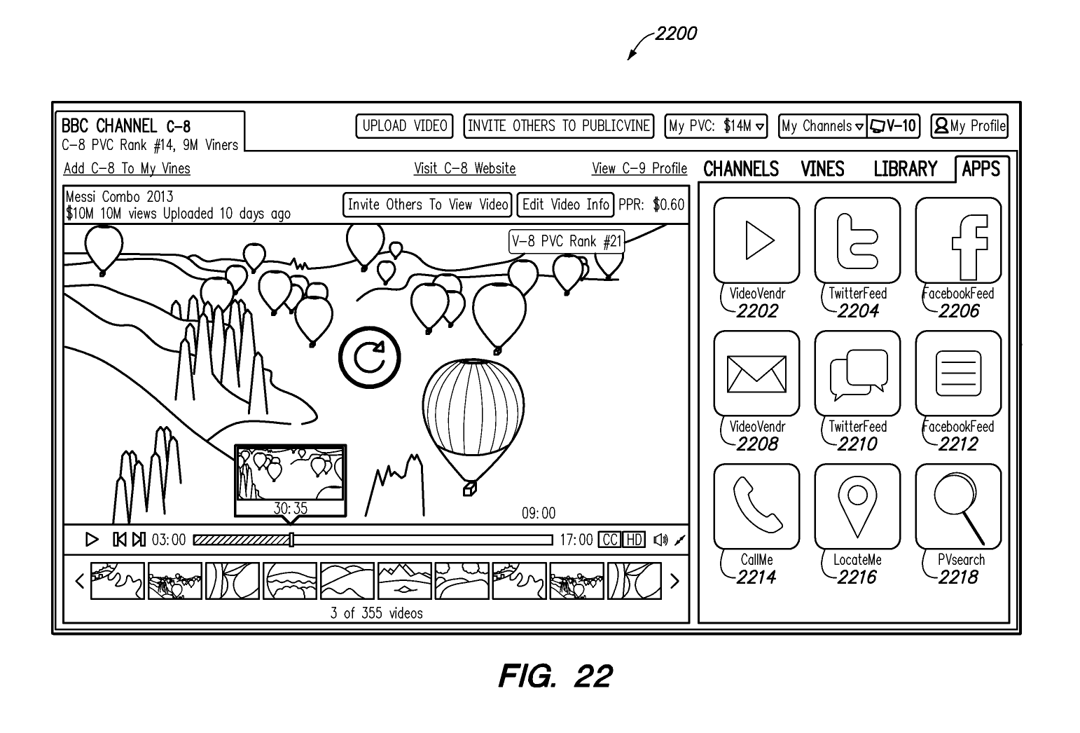

At block 544, the system stores access to purchase or rented video contents in the consumer's library (see FIG. 23). Since consumer viners cannot offer or rent video content, each consumer viner has a library for storing content that is purchased or rented.

At block 546, the process is terminated.

Returning to decision block 512, after vendor viner 104 has been assigned an exclusively identifiable channel e.g., Vendor-22, if vendor viner 104 does not wish to upload video content, the process proceeds to block 548.

At block 548, vendor viner 104 invites one or more of his or her contacts on an external social network to join the transactional social media platform. Note that viners can either send invitations to external contacts to view video content or to register on the platform. Thus, another advantage of the present invention is that the invite system is viral.

Vendor viner 104 within the transactional social media platform can send invitations to external contacts. In turn, after registering on the platform, the registered external contacts, now viners can then send invitations to other external contacts via the same invite system, thus growing the viner base of the transactions social media platform. Similarly, if the invitation is a video view invite to an external contact, the external contact after registration can send the same video view invitation to both viners and external contacts outside of the platform.

Note also that unlike conventional social media networks that send links that share videos, the transactional social video platforms sends invitations including data objects, discussed below, the invitations requiring the external users to preview video content after registration and to access such video content upon payment for the video content.

As noted, vendor viner 104 to communicates or sends to the external contact outside the transactional social media platform, an invitation for the external contact to register with the platform. In one embodiment, the invitation includes a data object that identifies the video viner 104 and the invited external contact. For example, the data object may include the following fields: 1) inviter_viner_id: 123321; 2) inviter_viner_name: vendor viner 104; invitee_id: 2348; invitee_name: john_doe. The data object associates the inviter viner and the invitee external user.

This is another advantage of the present invention. The transactional social media platform uses the data object to determine new users and to track a new user that is invited by a specific viner. Here, for example, the data object may be used to identify that the new viner was invited by video viner 104. Associating new users and inviters, if any, has significant ramifications because of the revenue sharing system of the present invention as further described elsewhere in this disclosure. Whenever the new viner generates revenue either because the viner is a video viner that sells or rents out content or because the viner is a consumer that buys content, the inviter viner that invited the new viner also receives an allocable portion of the revenue.

At decision block 550, the invited contacts may accept or decline an invitation to join a network. If the users decline the invitation to join a network, the process proceeds to end block 546 where the process is terminated.

If the users accept the invitation to join the transactional social media platform, the process proceeds to block 508 where the invited user is registered as a consumer or vendor. If the invited user is a vendor as previously discussed, a vendor channel is allocated at block 510A followed by implementation of the previously discussed steps.

If an invited user is a consumer, a consumer channel is allocated at block 510B, and thereafter, at decision block 552, it is determined whether the consumer was invited to watch video content by a vendor viner (i.e., vendor viner 104) to watch the video content. If the consumer was not invited by a vendor viner to watch the content, as in such cases where the consumer or user is registering without any invitation, the process proceeds to block 546 where it is terminated.

If the consumer is an invited user (invited by a vendor viner to watch video content), the process proceeds to block 554.

At block 554, the system adds the consumer to the vendor viner's holdingvine after which the process proceeds to block 536.

At block 536, the consumer can now preview a video since the consumer was initially invited to view video content. A consumer can then proceed to the remainder of the steps as were previously described to choose, pay and access content.

Static Revenue Sharing

Another advantage of the present invention is that viners that refer other viners to view content and/or register with the transactional social media platform are allocated a portion of revenue derived from video content sales or rentals. In one embodiment, “Static Revenue Sharing,” may be used to allocate revenues. In FIG. 10C, static revenue sharing shares video content revenue between the vendor viner 1060 that sold (or rented out) video content, the transactional social media platform 1062 within which the video content transaction occurred, the vendor inviter 1064—the viner that invited the vendor to the platform, and consumer content/purchaser (or renter) inviter 1066—the viner that that invited the consumer to view and purchase the vendor viner's video content.

Between the four participants, the entirety of the video content revenue generated from rental or sales is shared. This 100% also takes into account the percentage of the price allocated for the bandwidth, storage, and encoding (BASE) cost. The static revenue shares are determined by the following equations:

R_{V}=V=K(PPR−BC)[P_{V}+(!f_{V}?:0)+( [symbol] VVI?P_{VVI}:0)]

R_{PV}=PV=K(PPR−BC)[P_{PV}+( [symbol] VI&& f_{V}?P_{VI}:0]

R_{W}=WS=w?PV min(P_{WR}+P_{WB},P_{WM}):0

R_{PV}=PV=PV−WS

R_{VI}=VIC=K(PPR−BC)(^{∃}VI&&f_{VI}?P_{VI}:0)

R_{VVI}=VVIC=K(PPR−BC)(^{}VVI?P_{VVI}:0)

where the variables, constants, abbreviations, notations and operators are described with reference to in or about paragraph 233 below.

Viral Revenue Sharing

In a second embodiment, viral revenue sharing further shares the vendor viner's and consumer viner's static revenue and allows them to geometrically monetize their social networks by generating viral revenue commissions when there are inviters beyond the four participants 1060, 1062, 1064 and 1066 in the static revenue scheme.

In FIG. 10C, additional participants may include inviter 1068 that invited vendor 1064 to register on the platform; inviter 1080 that invited consumer/content purchaser inviter 1066 to register on the platform and inviter 1082 that invited consumer/content purchaser inviter 1066 to view and purchase or rent video content.

Note that inviters 1068, 1080 and 1082, etc. may or may not exist. And, for consumer/content purchaser inviter 1066, two possible inviters or inviter lines may exist: 1) the viner (and subsequent viners) that might have invited consumer/content purchaser inviter 1066 to register on the platform represented by PVIL (PublicVine Invite Line) 1073 of FIG. 10C and the viner that may have invited consumer/content purchaser inviter 1066 to view (purchase or rent) video content represented by VVIL (Video View Invite Line) 1074.

In contrast to consumer/content purchaser inviter 1066 where two possibilities exist, for vendor inviter 1064, only one possibility exists: the viner that might have invited vendor inviter 1064 to register with the platform represented by VIL (Vendor Invite Line) 1072 of FIG. 10C.

Therefore, if one or more of inviter 1068, 1080 or 1082 exist, then a single geometrical level of payments that must be made to the inviters is added to the static revenue payments. Each geometric level is represented by lines “n” on the x axis, e.g. level 1 shown as 1076, level 2 shown as 1078, etc. The viral revenue commission (vrc) generated for each individual inviter are based on the following equations. In this manner, when a viner invites an external user that registers and becomes a new viner, in one embodiment, everytime the new viner receives payment, the inviter viner also receives a payment.

Levels: For VIL & VVIL (see 1072 and 1074 of FIGS. 10C and 10D), the effective number of levels nl (see 1076, 1078 of FIG. 10C) etc. for viral revenue sharing, for a given invite line L, excluding static level 0 is:

$${nl}_{L} = min ( ml , {al}_{L} ) \\ = min ( ⌈ {log}_{10} max \{ P P R + 0.01 , FC \} ⌉ + IL - {log}_{10} FC , {al}_{L} ) ,$$

so

nl_{VIL}=min( [symbol] log₁₀max{PPR+0.01,FC} [symbol] +IL−log₁₀FC,al_{VIL})

nl_{VVIL}=min( [symbol] log₁₀max{PPR+0.01,FC} [symbol] +IL−log₁₀FC,al_{VVIL})

On VVI lines we may have PVI lines branching out at each node (FIG. 10D), each branch of which will have its own al:

nl_{PVILr}=min( [symbol] log₁₀max{PPR+0.01,FC} [symbol] +IL−log₁₀FC−r,al_{PVILn})

where PVILᵣ is the PVI line branching out of its root VVI node at level r. Note that nl_{PVIL} does not include its root VVIᵣ node, or any other node before that (hence −r−1).

Nodes: The maximum number of viral nodes mn (i.e. the highest possible number of viral beneficiaries of a transaction) grows exponentially with respect to the maximum number of levels ml, at a rate of O(ml²). Nodes on static level 0 (VI₀ and VVI₀) are not considered viral nodes:

mn(ml)=0.5ml²+2.5ml

The maximum number of viral nodes ln at level n is: ln(n)=n+2

Viral Revenue Commission: The effective/final viral revenue commission vrc for a node at level n on an invite line L, is defined by the following recursive function, where r is the root level for L, and T is the split ratio of the root's 10% to which L is entitled (T_{VIL}, is 100%; T_{VVIL} and T_{PVIL} are both 50%).

vrc(n,r)_{L}=T_{L}VRC_{Lr}/10^{n-r}−Σᵢ₌ₙ₊₁^{nl+T-1}vrc(i,r)_{L}0≦n<nl_{L}

Here, VRC_{Lr} is the initial shareable viral revenue commission at node (L, r):

VRC_{Lr}=VRC_{Lr(r-1)}/10 where VRC_{L(-1)}=PPR

For VIL & VVIL, where 0≦n<nl_{VIL}, and 0≦n<nl_{VVIL} respectively, and r is always 0:

vrc(n,0)_{VIL}=T_{VIL}VIC₀/10ⁿ−Σᵢ₌ₙ₊₁^{nl-1}vrc(i,0)_{VIL}

vrc(n,0)_{VVIL}=[T_{VVIL}+(∃PVIₙ∥(n=nl_{VVIL}−1)?T_{PVIL}(∃PVIₙ?0: T_{PVIL}))]VVIC₀/10ⁿ−Σᵢ₌ₙ₊₁^{nl-1}vrc(i,0)_{VVIL}

For PVIL, where 0<n<nl_{VVIL}, and n<r<nl_{VVIL}:

vrc(n,r)_{PVIL}(∃PVIᵣ?T_{PVIL}: 0)VVICᵣ/10^{n-r}−Σₗ₌ₙ₊₁^{nl+r}vrc(l,r)_{PVIL}

Algorithm: The above equations are applied to a transaction in a tree topology, and vrc calculations can proceed along the tree in 2 ways. Method 1 might be faster while method 2 is more applicable where the tree topology is known.

1) Forward—from root to leaves. Calculate node commissions nc (vrc) while building the tree, starting at root level 0.

2) Backward—from leaves to root. Build the tree first starting at root level 0, then calculate nc starting from leaves.

The algorithms to determine viral revenue commission at each level for all invite lines are therefore:

Forward—calculates vrc while building tree:

| | |
|---|---|
| for L in [VIL, VVIL] | for each major line VIL and |
| n = −1 | VVIL initialize VIL/VVIL |
| | level to −1 (PPR), so that |
| | next level is 0 |
| while I_{L}(++n) | while there's a line inviter on |
| | the next level, jump a level up |

| | |
|---|---|
| nc_{L,n} = T_{X}VRC_{Ln} − (I_{L}(n+1) ? VRC_{L(n+1)} : 0) | at current |
| | VIL/VVIL |
| | node, |
| | calculate vrc |

| | |
|---|---|
| p = n | init. PVIL level to cur. VVIL |
| | lev. n, so that next level is |
| | 1^{st} PVIL lev. |

| | |
|---|---|
| while L is VVIL, and I_{PVIL}(++p) | for VVIL, while there's a |
| | PVIL inviter on the next |
| | level, jump a level up |

```
                  nc_{PVILn,p} = T_{X}VRC_{PVILp} − (I_{PVILn}(p+1) ?
                  VRC_{PVIL(p+1)}: 0)
```

at current PVIL node,
calculate vrc

Backward—assumes tree is built:

| | |
|---|---|
| for L in [VIL,VVIL], where nl_{L} > 0 | for each major line VIL |
| for n = nl_{L}−1 downto 0 | and VVIL work down the |
| | nodes from highest to |
| | static level 0 |
| nc_{L,n} = vrc(n,0)_{L} | at current VIL/VVIL node, |
| if L is VVIL, and n < n_{VVIL}−1 | calculate vrc if current line |
| | is VVIL, and not on the |
| | highest level node |

| | |
|---|---|
| for p = nl_{PVILn}+n downto n+1 | work down the |
| | PVIL line branching |
| | out of the current |
| | VVIL node |
| nc_{PVILn,p} = vrc(p,n)_{PVIL} | at current PVIL |
| | node, calculate vr |

Variables and functions used in equations above: the actual number of levels (or nodes) for viral revenue sharing, for a given line (inclusive of static level 0—this applies to any count of levels, i.e., IL, ml and nl except

C_{b} cost of BW per MB ($)
cₑ cost of SD encoding per min ($)
cₕ cost of HD encoding per min ($)
cₛ cost of monthly storage per MB ($)
d duration of video, rounded up to the nearest minute (function, mins)
e encoded video
f freshness (fᵥₗ is true if vendor invite is fresh, i.e., <1 year old; otherwise fᵥₗ is false) (function, boolean)
ln (level nodes) number of nodes at a given viral revenue sharing level (across all invite lines)
ml maximum number of levels for viral revenue sharing, applicable to all lines (determined by PPR)
mn maximum number of viral nodes (viral beneficiaries) for a given transaction
nc_{Ln} node commission (the commission for a given line L, at a given level n)
nl effective number of levels for viral revenue sharing, for a given line (the lesser of ml and al)
p_{wR} percentage of wholesaler's subscriber base registered onto PublicVine by wholesaler (%)
s size of video (function, MB)
u uploaded video
v generic video variable
w wholesale transaction (function, boolean)
E set of all encoded videos
H set of all HD encoded videos
S set of all SD encoded videos
|H| quantity of all HD encoded videos
|S| quantity of all SD encoded videos

Constants Used in the Above Equations:

| | | |
|---|---|---|
| FC | 10 | first cutoff price to determine number of levels for viral revenue sharing ($) |
| K | 0.95⁻¹ | proration coefficient for static shares. K = 100%/(100% − P_{BC}) |
| IL | 3 | minimum number of levels for viral revenue sharing (inclusive of static |
| | | level 0) |
| MPF | 5 | price floor multiple (of BC) |
| MSP | 20 | suggested price multiple (of BC) |
| P_{BC} | 5 | static share of SPPR for base cost (%) |
| P_{PV} | 20 | static share of SPPR for PublicVine (%) |
| P_{V} | 55 | static share of SPPR for vendor (%) |
| P_{VI} | 10 | static share of SPPR for vendor inviter (%) |
| P_{VVI} | 10 | static share of SPPR for video view inviter (%) |
| P_{WB} | 20 | minimum share of PublicVine's PPR share that can go to wholesaler |
| | | (%) this value also acts as a bonus, i.e., it is always added to p_{WR} |
| P_{WM} | 80 | maximum share of PublicVine's PPR share that can go to wholesaler |
| | | (%) |
| T_{PVIL} | 50 | split ratio for PVI line branching out of a VVI node (%) |
| T_{VI} | 100 | split ratio for VI line (%) |
| T_{VVI} | 50 | split ratio for VVI line branching out of a VVI node (%) |
| SPE | 100 | number of monthly views over which to spread one-time encoding cost |
| SPS | 10 | number of monthly views over which to spread monthly storage cost |

Abbreviations Used in the Above Equations:

| | |
|---|---|
| BC | base cost |
| PF | price floor |
| PPR | price per rent (set by vendor) |
| PV | PublicVine/PublicVine's Share of PPR (determine by context) |
| PVI | PublicVine invite(r) (determine by context). This term is mainly used for PV |
| | invite lines branching out of VVI nodes, and should not be confused with the |
| | PV invite line associated with the vendor invite(r) |
| PVIL | PublicVine invite line branching out of a VVI node |
| SPPR | suggested price per rent |
| V | vendor/vendor's share of PPR (determine by context) |
| VI | vendor invite(r) (determine by context) |
| VIC R_{VI} | vendor invite commission of PPR ($) |
| VIL | vendor invite line |
| VRC | shareable/initial viral revenue commission at a node on a given line and level, |
| | which is to be shared with that node's subtree (for VIL & VVIL, these are VIC₀ |
| | and VVIC₀ respectively. For PVIL, this is the total VVIC amount available for |
| | the entire subtree originating at the PVIL's root VVIᵣ) |
| VVI | video view invite(r) (determine by context) |
| VVIC R_{VVI} | video view invite commission of PPR ($) |
| VVIL | video view invite line |
| WS R_{W} | wholesaler share of PPR ($) |

Notation Used in the Above Equations:

| | | | |
|---|---|---|---|
| ∃ | existence | ∃VVI | video view inviter exists |
| [symbol] | non-existence | [symbol] VVI | video view inviter does not exists |
| ∈ | set membership | v∈E | all elements (videos v) that belong |
| | | | to the set E of all encoded videos |
| \|\| | set cardinality | \|H\| | number of elements (videos) in set |
| | | | H of all HD encoded videos |
| Σ | summation | Σ_{v∈ε} sᵥ | the cumulative size of all |
| | | | encoded videos |
| | | Σᵢ₌ₙ₊₁^{nl-1} v(i) | the cumulative sum of v(i), for i |
| | | | staring at n + 1 and ending at |
| | | | nl − 1 |

Psuedo-Code Operators Used in the Above Equations:

| | | | |
|---|---|---|---|
| ! | NOT / | ! fᵥ | vendor is not fresh (vendor's age on |
| | negation | | platform ≧1 year) |
| && | AND | a && b | condition a is true, AND condition b |
| | | | is true |
| c ? x : y | ternary | a = c ? x : y | if condition c is true, a = x; |
| | operator | | otherwise, a = y |

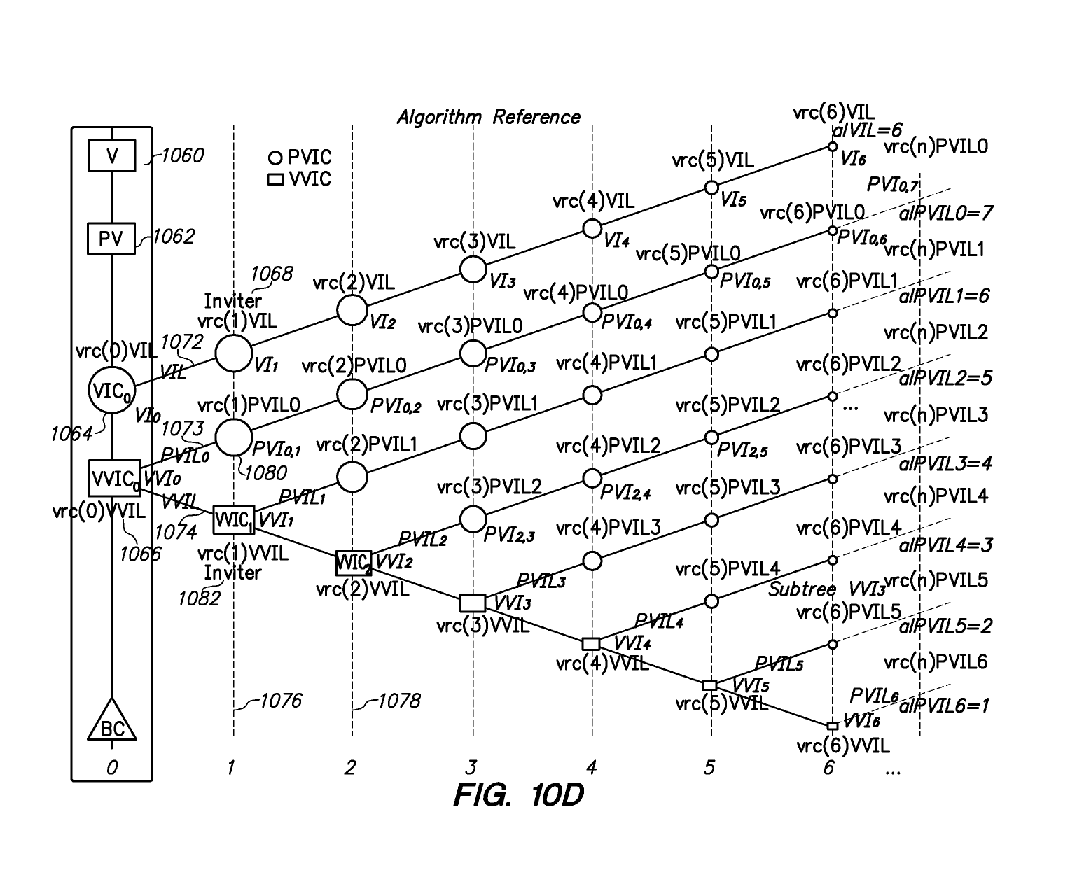

FIG. 11 illustrates vendor-on-vendor interface screenshot 1100 according to an exemplary embodiment of the present invention.

In FIG. 11, registered user vendor viner 104 can use this vendor-on-vendor interface 1100 to view video content on other vendor channels and to display his or her own vine groupings and their corresponding viners. Thus, although vendor viner 104's assigned channel is V-10 as shown at 436, vendor viner 104 has selected content for display from another channel—National Geographic Channel V-200 as shown at 1102. Specifically, vendor viner 104 has selected to watch “Messi Combo 2013” 1106 from channel V-200 as shown at 1102.

Thus, users such as vendor viner 104 are not limited to viewing their own channels or consumer channels. They can also view other vendor channels to preview video content on those vendor channels in order to keep current as to what other vendor viners are offering.

Vendor viner 104 may also use vendor-on-vendor interface 1100 to displayvine groupings 1105 in which the vendor viner 104's contacts are stratified. Specifically, vendor viner 104 may select vines tab 424 to display drop-down buttons for schoolvines 1106, workvine 1108, playvine 1110, familyvine 1112, spiritualvine 1114, favoritevine 1116, holdingvine 1118 and another drop-down button for externalvine 1120.

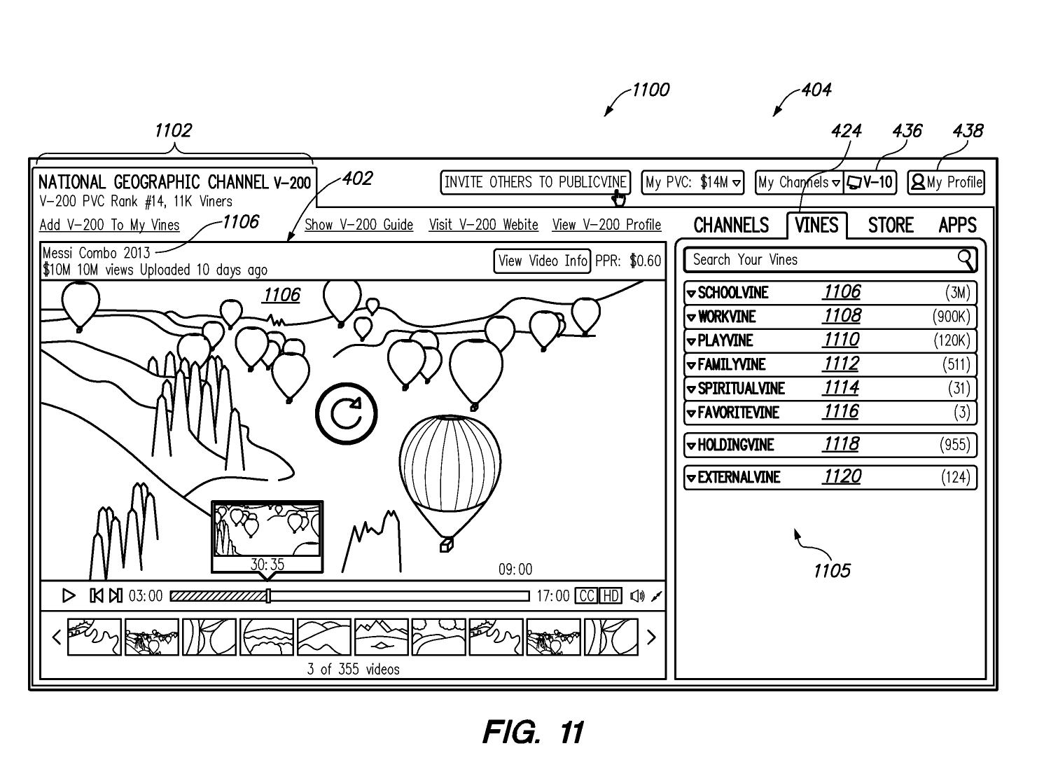

Each of these vines includes stratified contacts, friends, fans or the like that are stratified as previously noted in two different categories. Here, as shown in FIG. 11, schoolvine 1106 has approximately three million contacts while the externalvine has 124,000 contacts. When each vine is selected via its corresponding drop-down button, a listing of all the contacts within that vine is thereafter displayed as illustrated in FIG. 12.

FIG. 12 illustrates expanded vendor-on-vendor interface screenshot 1200 according to an exemplary embodiment of the present invention.

In FIG. 12, vendor viner 104 uses vendor-on-vendor interface 1200 to display a listing of viner contacts in each vine category. For example, selecting workvine 1108 displays viner contacts in the workvine group. The viner contacts include channel V-45 owned by DNC (Democratic National Committee), invited by Bill Clinton, etc. as shown at 1110. A second contact in workvine 1108 is channel V-102 owned by New York Times and invited by John Ryan, etc. as shown at 1112.

Note that the contacts within one social graph or vine are not mutually exclusive vis-à-vis another vine. For example, contact DNC and channel V-45 may be part of workvine 1108 and can also be part of favoritevine 1116. Although not shown, viners may be added, may be moved, edited, or moved from one vine to another vine or may be deleted in their entirety. In this manner, the present invention allows vendor viners to display their contacts in different social graphs and/or categorize such contacts according to their needs. It is also noted that the vines that may be created are not limited to those disclosed.

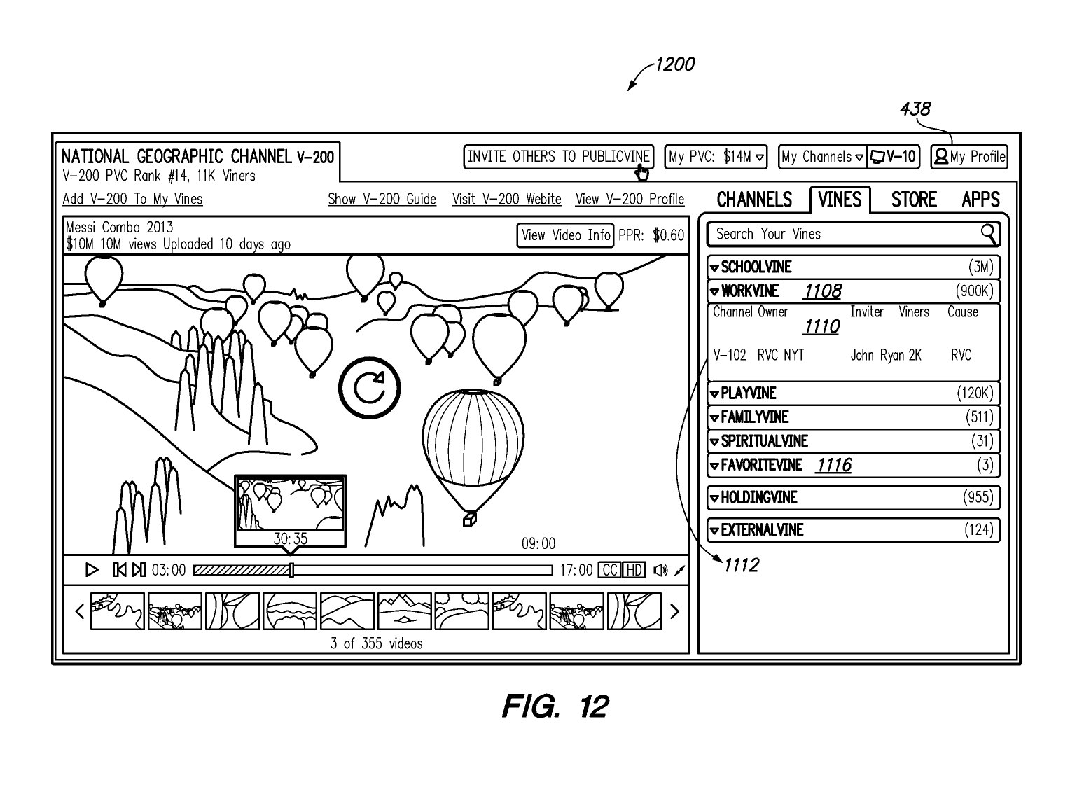

FIG. 13 illustrates vendor's own interface screenshot 1300 according to an exemplary embodiment of the present invention.

In FIG. 13, vendor viner 104 can use vendor's own interface 1300 to change settings 1302, to view vine invites 1304, to edit basic information 1306, to display statistics 1308, to display education profile 1310 for the vendor 104, to display work information 1312 and to assign privileges 1314.

Vendor viner 104 may access this interface by selecting the “My profile” button 438 of FIG. 4. Note that vendor's own interface 1300 represents vendor viner 104's home page as can be seen at 436 which displays the channel V-10 that is assigned to vendor viner 104 as well as at 408 which shows that the current channel being viewed by vendor viner 104 is also channel V-10, History Channel.

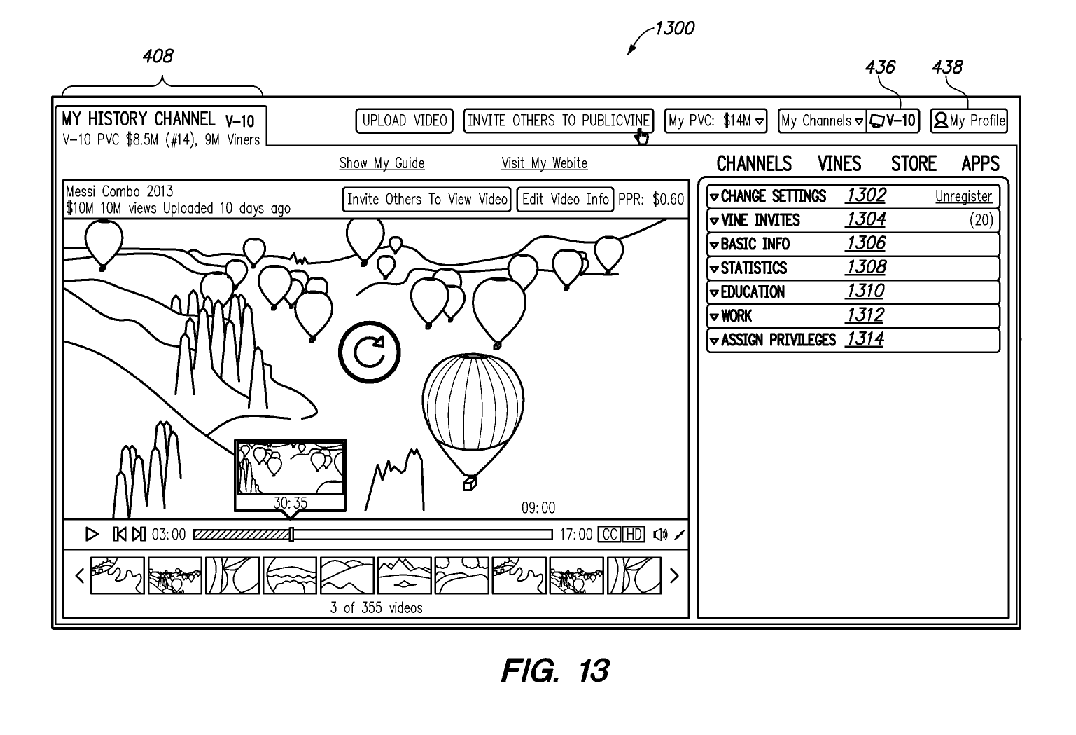

FIG. 14 illustrates vendor viner's own interface screenshot 1400 according to an exemplary embodiment of the present invention.

In FIG. 14, this vendor viner's own interface screenshot 1400 can be employed to change channel settings by selecting change settings 1302 of FIG. 13. Thereafter, channel settings 1402, mobile settings 1404, social settings 1406 and FTP settings 1408 are displayed.

Selecting channel settings 1402 displays information relating to the current channel that is assigned—in this case, V-10. Once the information for channel settings is displayed, vendor viner 104 can select drop-down buttons to edit fields and/or to change the default channel V-10, to change the channel name or channel sub-group or channel rating or website, and in fact, vendor viner 104 can add a new channel by selecting button 1412.

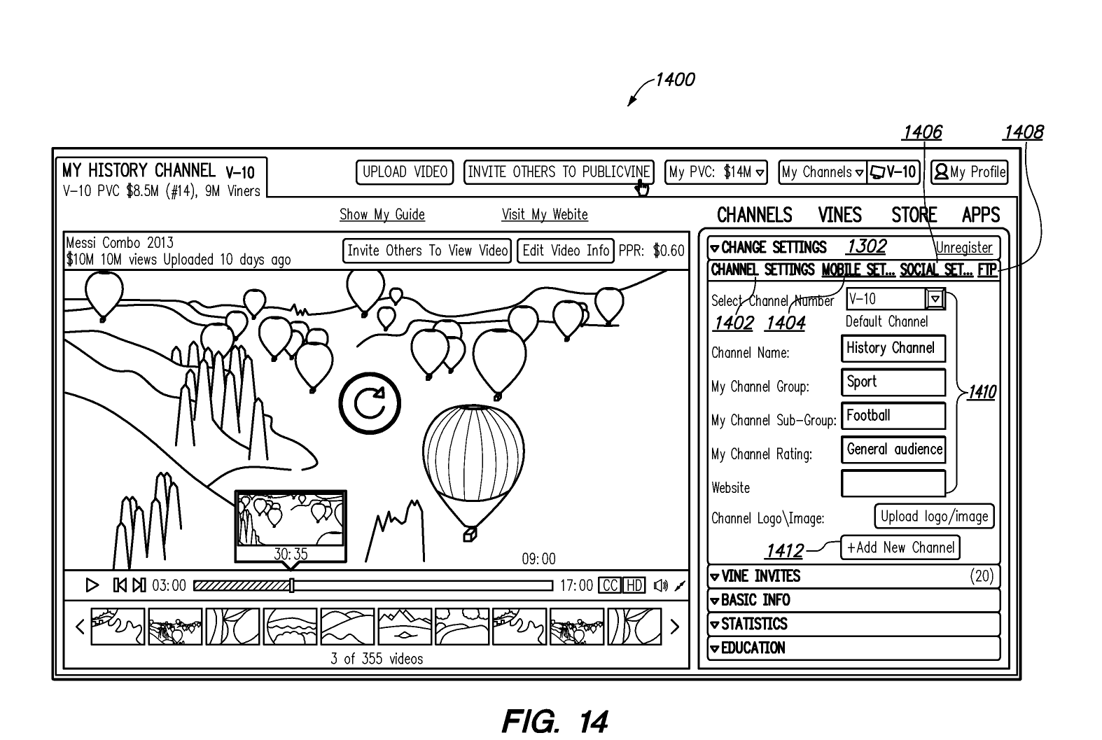

FIG. 15 illustrates vendor viner's own interface 1500 screenshot according to an exemplary embodiment of the present invention.

In FIG. 15, vendor viner's own interface 1500 has external social media settings to facilitate informing external contacts that video content has been uploaded and to send video view invitations to external contacts. After selecting social settings 1406 of FIG. 14 to display vendor viner's own interface 1500, vendor viner 104 then selects upload video 1502 to send a message to external contacts on Facebook™, Twitter™ or Google™ (or any other currently existing social media platform or communication system consistent with the spirit and scope of the present invention) that video content has been upload to the transactional social media platform. Vendor viner 104 may also select send “send invitation” 1504 to send invitations to view the new video content to contacts on Facebook™, Twitter™ and Google™.

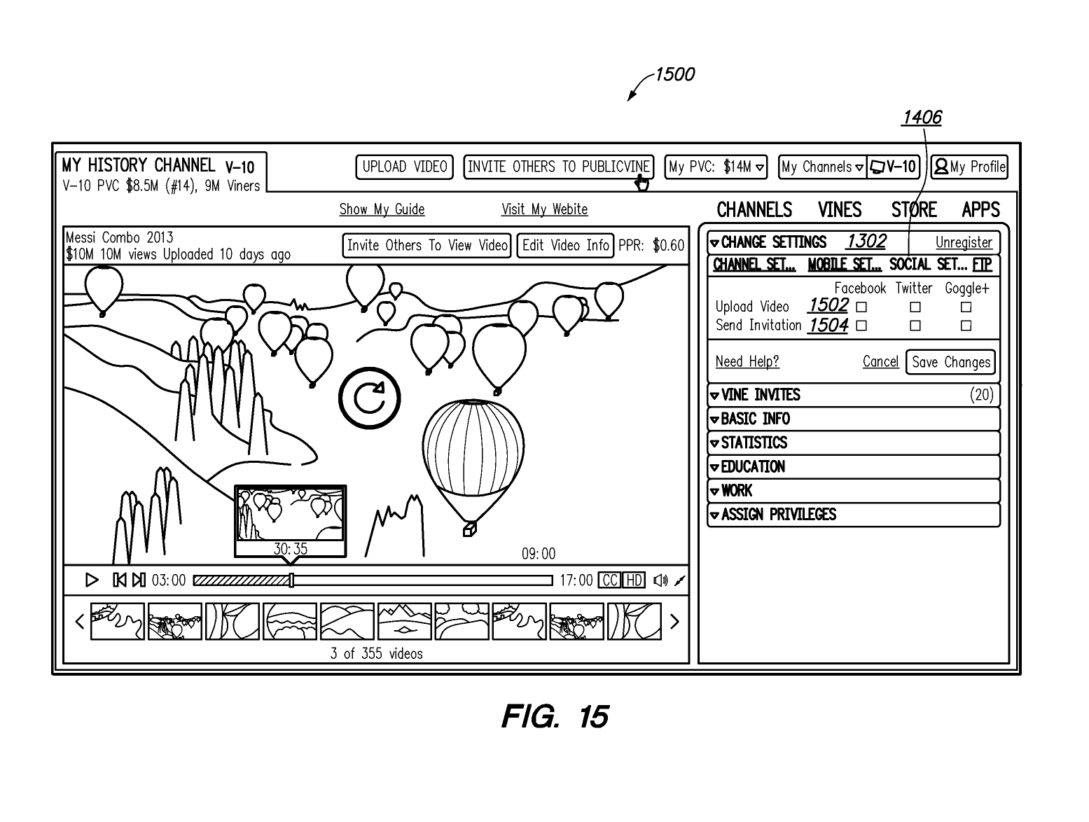

FIG. 16 illustrates vendor viner's own interface screenshot 1600 according to an exemplary embodiment of the present invention.

In FIG. 16, vendor viner's own interface screenshot 1600 is displaying a sub-menu for vine invites 1304 of FIG. 13. When vine invites 1304 is selected, sub-menu 1606 is displayed. Specifically, here, vendor viner's own interface 1600 shows that a contact “Sameer of Mumbai” has invited vendor viner 104 to join his vine.

If vendor viner 104 wishes to join Sameer's vine, he or she may simply select “accept invitation” 1608 to accept and join Sameer's vine. Of course, vendor viner 104 may also select “reject” 1610 to reject the invitation. An advantage of the present invention is that responsive to Sameer's invitation, vendor viner 104 can also invite Sameer to join his or her network.

As can be seen at 1606, vendor viner 104 may select a checkbox for: all my vines 1612, schoolvines 1614, etc. Here, specifically, vendor viner 104 has selected checkbox for playvine 1616 and thereafter selects invite button 1618 after which a corresponding invitation is sent to Sameer. In this manner, unlike conventional social networking platforms, the present invention permits one party to send an invitation to another party and the other party to send a corresponding invitation such that if the invitations are accepted, each invitee now belongs to each other's social network. In another embodiment, one party may invite only; Further, yet one party may invite and the other may reject.

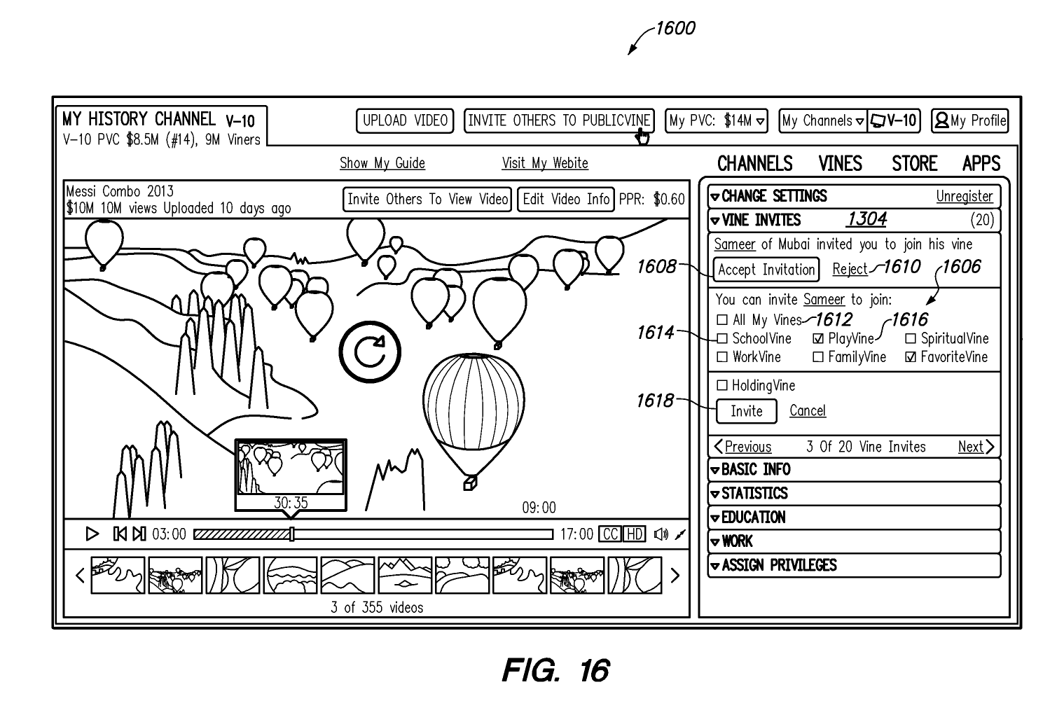

FIG. 17 illustrates vendor viner's own interface 1700 screenshot according to an exemplary embodiment of the present invention.

In FIG. 17, vendor viner's own interface 1700 is displaying a sub-menu that is displayed when assign privileges 1314 of FIG. 13 is selected. Vendor viner 104 can use assign privileges 1314 to assign certain privileges to different vines. Assign privileges 1314 grants members of a particular vine viewing access to vendor viner 104's information.

Access to that information can be based on specific fields. As shown here, vines are located in a single row 1702. Vendor viner's information or fields related to vendor viner's information are located in column 1704. The intersection of each column and row has a checkbox which, upon being checked, can provide the vine on the row access to the information in the column.

For example, here, checkbox 1706 has been selected. Checkbox 1706 is at the intersection of playvine 1708 and address 1710. Thus, every contact in vendor viner 104's playvine will have viewing access to vendor viner 104's address. In this manner, specific fields of information can be tailored to specific vines or groups of contacts.

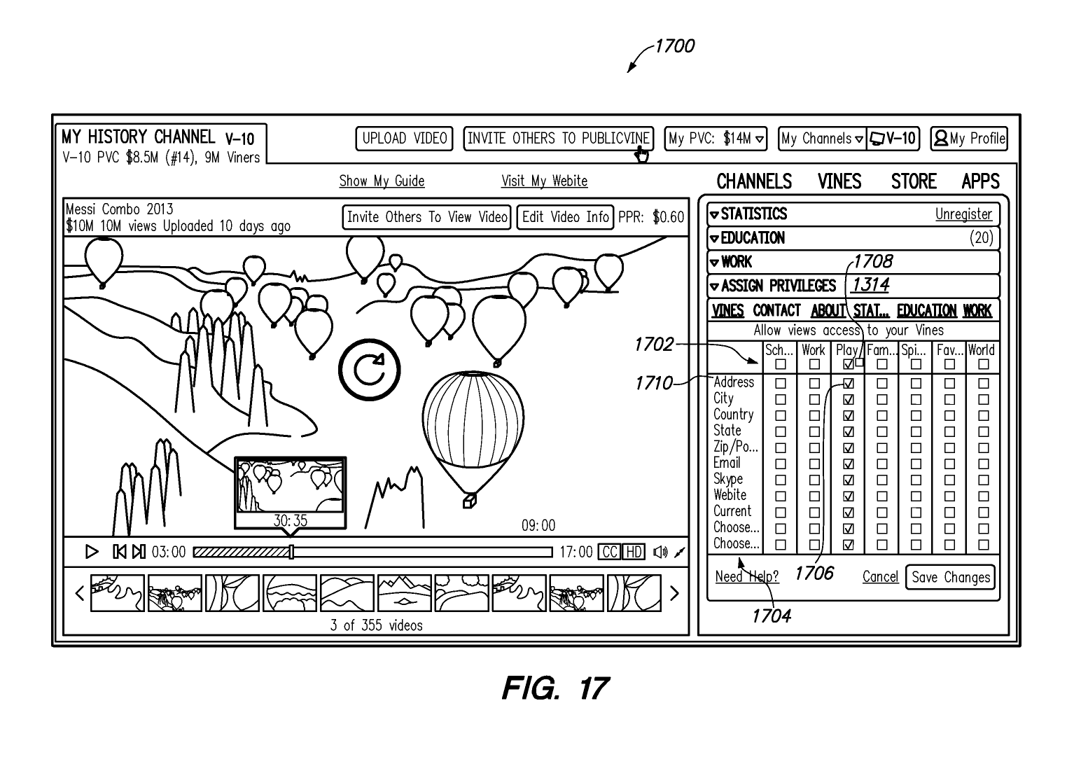

FIG. 18 illustrates a vendor-on-consumer interface 1800 screenshot [Put words on drawing.] according to an exemplary embodiment of the present invention.

In FIG. 18, vendor-on-consumer interface 1800 allows vendor viner 104 to access any consumer's channel for viewing purposes. Since consumers cannot offer video content for rent or sale, other users of the integrated social platform may only view consumer information. As shown here, vendor viner 104's channel is V-10 as shown at 436. Vendor viner 104 has, however, accessed V-8's video (1806) “Messi combo 2013” on consumer's channel C-8 as shown at 1802. As can be seen, library 1804 corresponding to consumer C-8 is also displayed. So, a vendor's video can be discovered in a consumer's library.

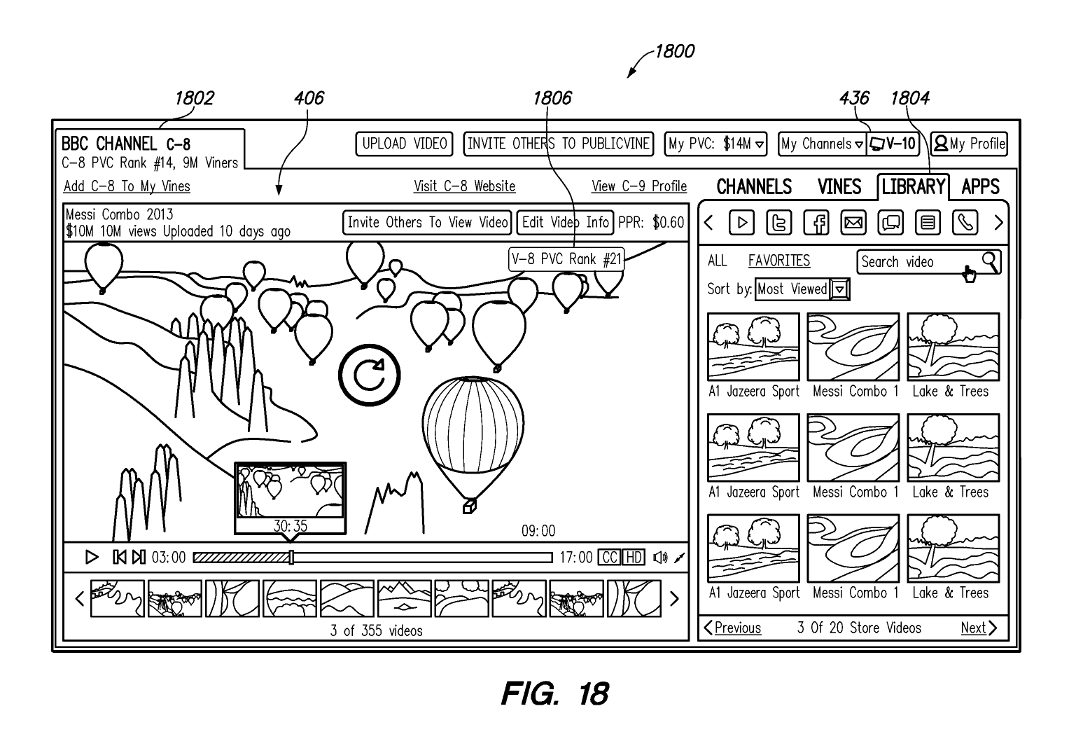

FIG. 19 illustrates consumer's own channel interface 1900 screenshot according to an exemplary embodiment of the present invention.

In FIG. 19, consumer's own channel interface 1900, as shown, enables consumer viner 102 to list video vendor channels 1902 as well as consumer channels 1920. Video vendor channels 1902 might include a plurality of categories including a sports channel 1904, music channel 1906, stand-up comedy 1908 and other plurality of channels as shown.

Video content that has been rented or paid for can be viewed within video display area 402. Video content from vendor viner store or consumer channels may also be previewed within the video display area 402. Note that consumer's own channel interface 1900 belongs to consumer viner 102 and represents the entirety of the world for consumer viner 102. All of consumer viner 102's contacts can be stored within this area.

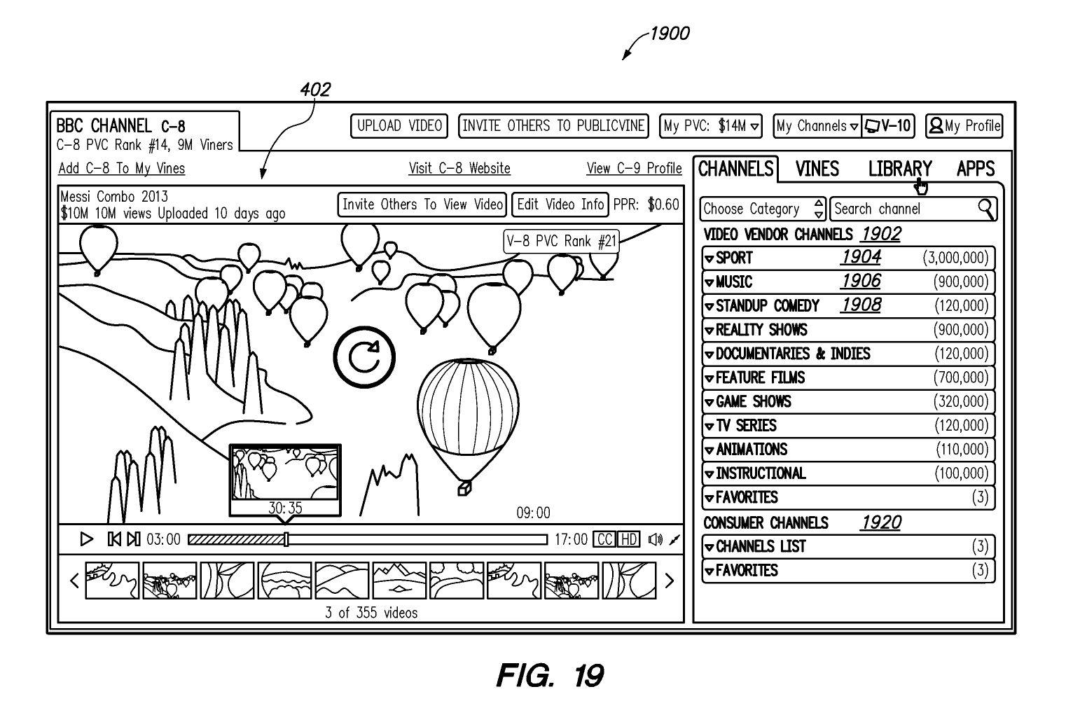

FIG. 20 illustrates consumer's own channel interface 2000 screenshot according to an exemplary embodiment of the present invention.

In FIG. 20, consumer's own channel interface 2000 specifically displays a plurality of sports channels after a drop-down button for sports channel 1904 of FIG. 19 is selected. Thereupon, various channels categorized as sports channels are displayed.

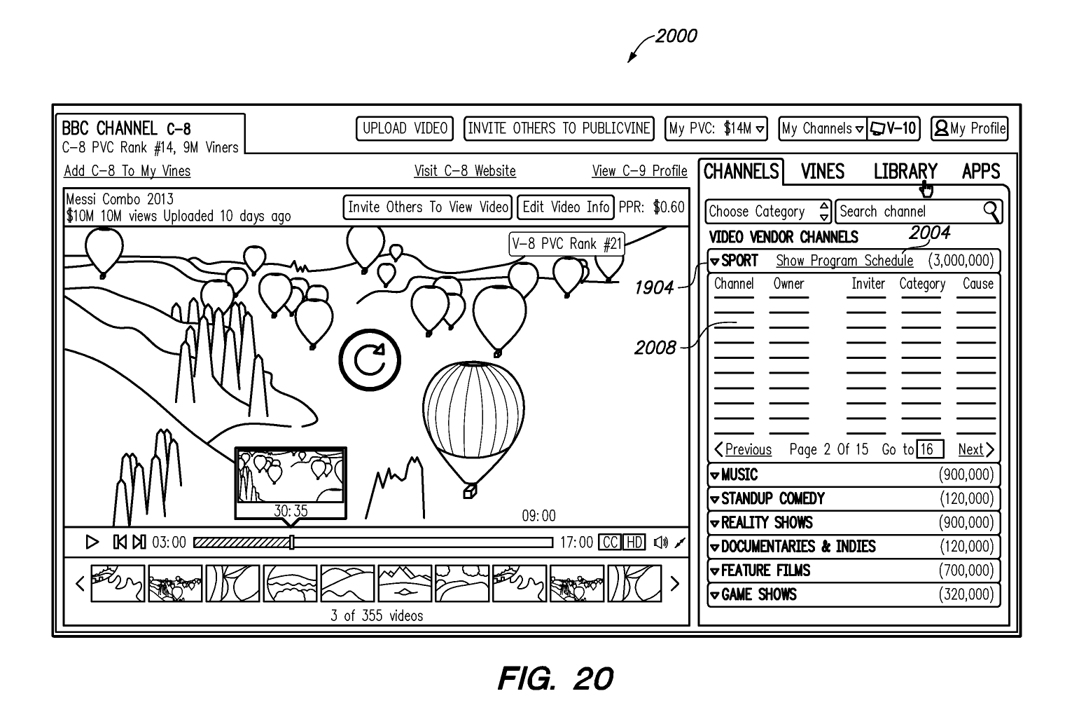

For example, channel V-45 owned by ESPN and sponsored by Disney with preview rating 14 is displayed as shown at 2008. Other sports channels are also shown as well. Consumer's own channel interface 2000 also includes a show program schedule link 2004 which, when selected, displays the sports live event guide of FIG. 21.

FIG. 21 illustrates sports scheduled event guide interface 2100 screenshot according to an exemplary embodiment of the present invention.

As shown in FIG. 21, the present invention facilitates scheduled sports events and enables consumer viner 102 to view such sports events live with the cost of viewing—that is renting or purchasing—being deducted from consumer viner 102's account. As can be seen at 2102 on channel V-102 owned by Messi football official, an interview with Leo Messi will be conducted live at 4:00 p.m. on Feb. 3, 2011, as an example. As another example, as shown at 2104 on channel V-2024 owned by David Becks, a soccer match between Nigeria and the United States will be available for viewing at 5:30 p.m. together with a post-game wrap-up.

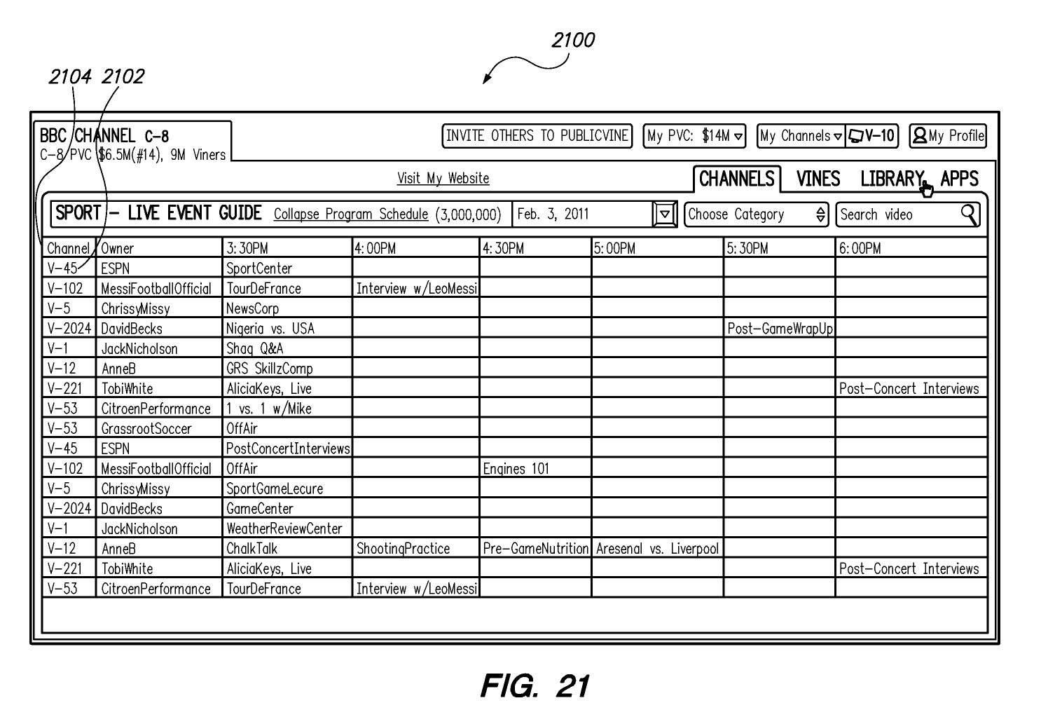

FIG. 22 illustrates consumer's own channel apps interface 2200 screenshot according to an exemplary embodiment of the present invention.

In FIG. 22, consumer viner 102 can select any one of a plurality of apps for various functionalities. Consumer viner 102 may select vendor viner social app 2202, may select Twitter feed 2204, Facebook feed 2206 and TV PublicVine mail 2208, PublicVine chat 2210 and PublicVine texting 2212. Other applications include call me 2214, locate me 2216 and PublicVine search 2218. One skilled in the art will realize that other applications are possible for use with the present invention.

FIG. 23 illustrates consumer's own channel library interface 2300 screenshot according to an exemplary embodiment of the present invention.

In FIG. 23, consumer's own channel library interface 2300 displays a plurality of thumbnails 2306 when tab 2304 is selected. The thumbnails represent video content that has been either bought or rented and appears in consumer viner 102's library. As consumers cannot rent out videos, they do not have libraries unlike vendor viners that have stores from which they can rent and sell videos.

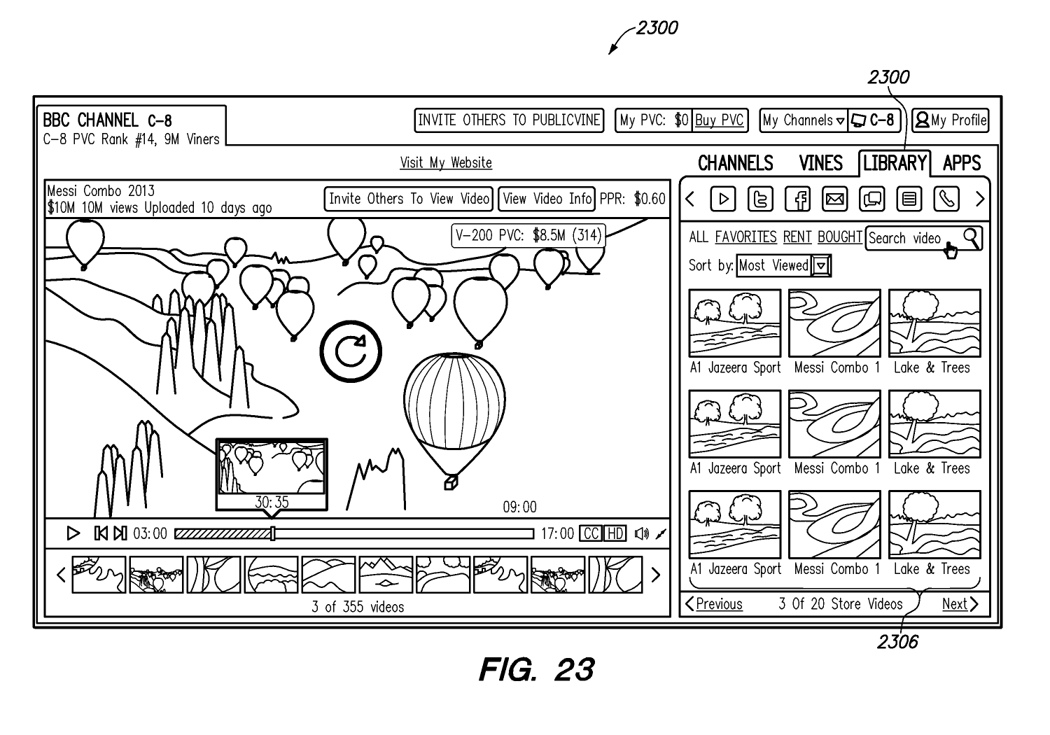

FIG. 24 illustrates edit video information interface 2400 screenshot according to an exemplary embodiment of the present invention.

In FIG. 24, when “edit video info” button 2402 is selected, sub-menu 2404 for editing video information is displayed. Using this menu, vendor viner 104 can set a price for rent or a price for buy. Here, as shown at 2406, vendor viner 104 has set the price for rent at $2.00, and as shown at 2408, the price for buy has been set for $10.00.

As previously noted, vendor viners may set buy or rent prices above or below the system-determined price for rent or buy. For example, as can be seen here at 2410, the suggested price for rent is $1.50. However, vendor viner 104 has elected to set the rent price for renting video content at $2.00. Vendor viner 104 may also see what portion of a given transaction is due the vendor viner.

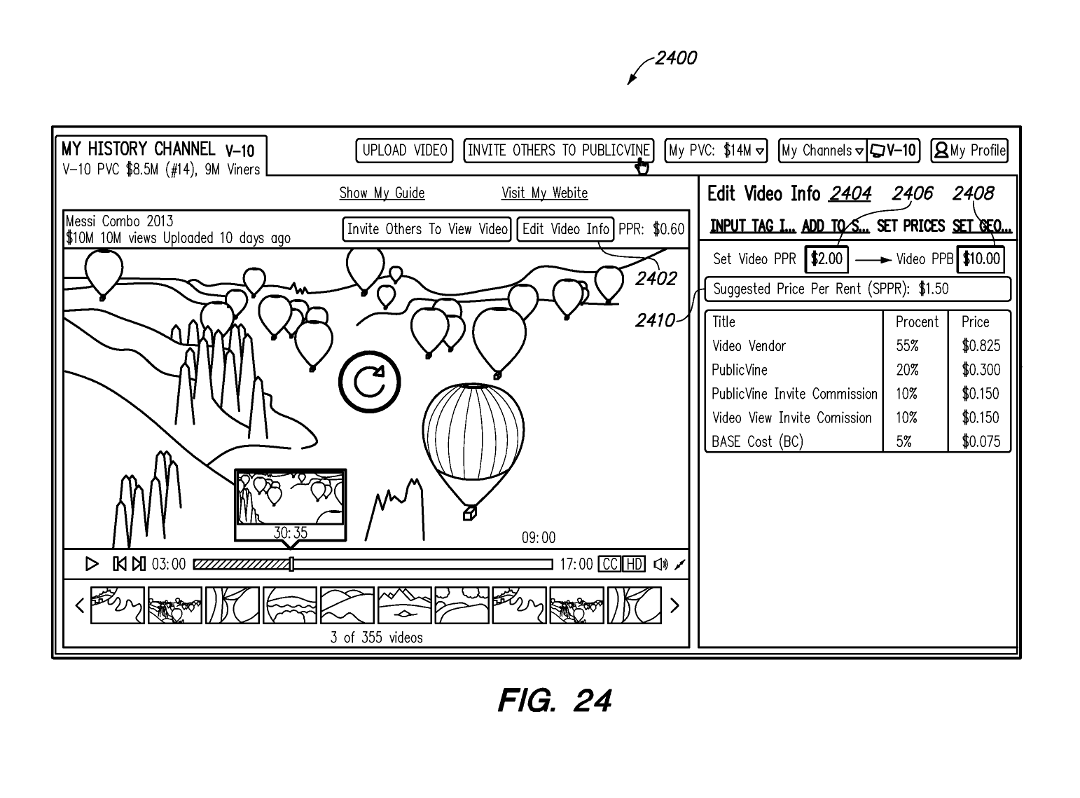

FIG. 25 illustrates video view invites interface 2500 screenshot according to an exemplary embodiment of the present invention.

In FIG. 25, consumer viner 102 uses video view invites interface 2500 by selecting “video view invites” 2504 to display video view invitations that are sent to consumer viner 102. Here, as shown at 2506, consumer viner 102 has received video invite 2506 from Amy White, another viner. Video invite 2506 includes thumbnail 2508 for the video content for which the invite is sent and text message 2510. Here, the text message states: “I′d like to invite you to view my pay-per-view video entitled Messi's Football . . . Viners get a great commission.” Consumer viner 102 may then select accept video invite 2512 to watch a preview of Messi's Football and either rent or purchase the video content if desired.

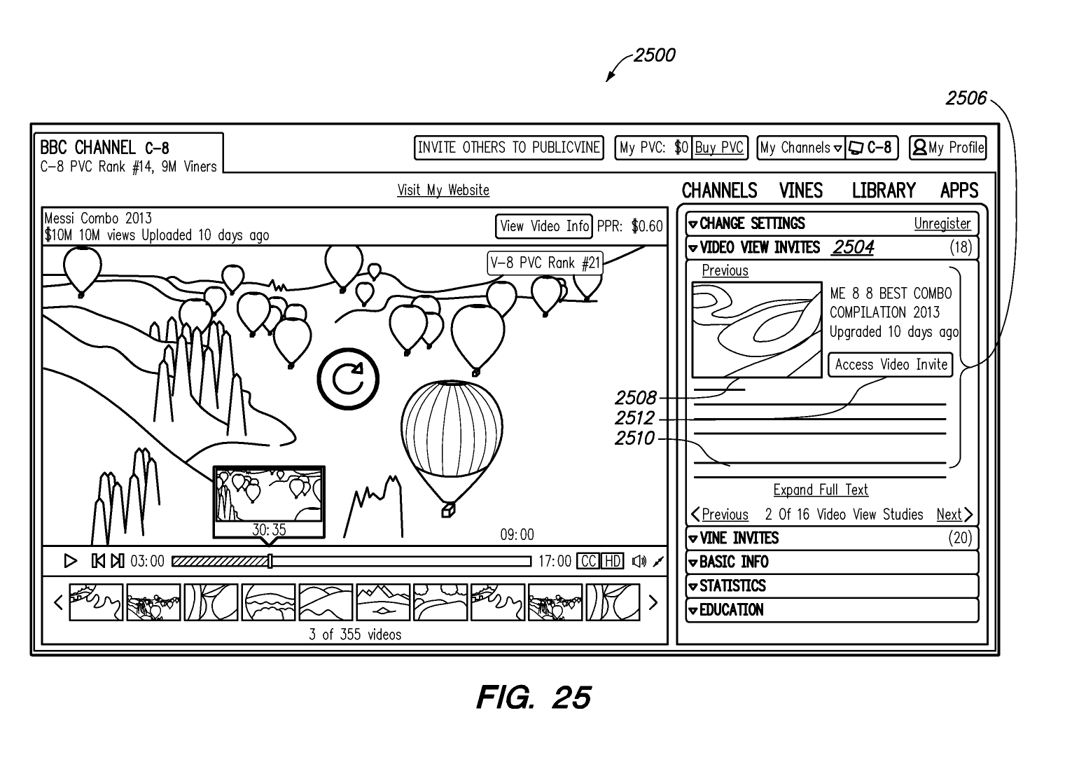

FIG. 26 illustrates rent-buy video interface screenshot 2600 according to an exemplary embodiment of the present invention.

In FIG. 26, consumer viner 102 that is assigned channel C-8 as shown at 2602 has encountered video content at another consumer channel C-20 as shown at 2604.

In the transactional social media platform, consumers often encounter video content on other consumer channels and may wish to rent or purchase such video content. Since consumers cannot offer rental or purchase of video content, video content encountered by a consumer must be rented from a vendor viner.

Here, consumer viner 102 has previewed video content after which “rent or buy” button 2606 is shown prompting consumer viner 102 to either rent or to buy the video content.

As shown, the system indicates that the cost for renting the video is $3.00/24 hrs. The cost for buying the video content outright is $9.00.

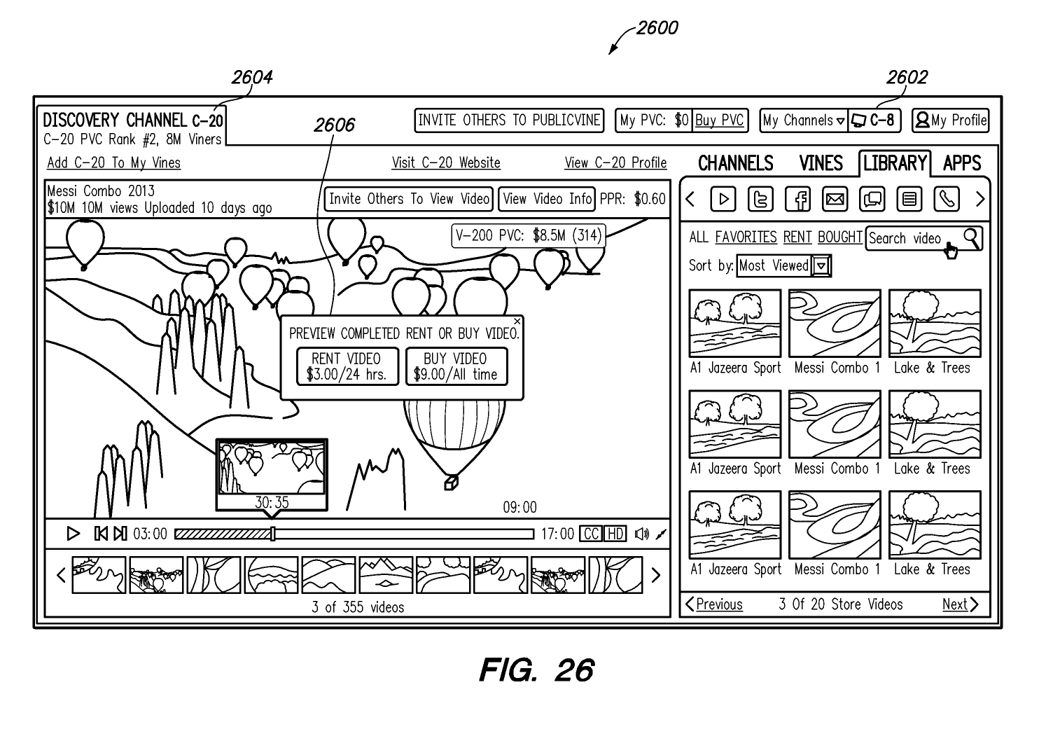

FIG. 27 illustrates video rent-buy payment interface 2700 screenshot according to an exemplary embodiment of the present invention.

In FIG. 27, once consumer viner 102 selects either the rent or buy button of “rent or buy” button 2606 of FIG. 26, video rent-buy payment interface 2700 is displayed to receive consumer viner 102's payment information. Note that commercial transactions are consummated using PVC (PublicVine Credits) which is social currency for the transactional social media platform. As previously noted, an advantage of the present invention is that it facilitates renting and purchasing of video content within the social media viral context, said video rent-buy payment interface 2700 providing a user interface for initiating and consummating said video content buy/sell transactions.

By using PVCs, consumers can load and store credits over and beyond their initial purchase amounts, thus reducing backend payment processing that occurs every time a purchase is made and saving the consumer's by not having to make payments every time a purchase is made and to save money by not having to pay transaction fees. Moreover, the present invention is a global platform with global consumers, some of which may have no access to credit card payments or the like. PVCs allow such consumers to pay using gateway cash and telecomm pay as you go units to purchase PVC credits, for example.

In one embodiment, the amount of PVCs that can be purchased depends on the U.S. dollar: e.g., $1=1 PVC. In an alternate embodiment, the amount of PVCs that may be purchased would depend on the national currency where the PVC is being purchased and need not necessarily be pegged to a U.S. dollar value.

In FIG. 27, video rent-buy payment interface 2700 includes PVC purchase form 2702 for collecting credit card information including card number 2707, card type 2708, expiration date 2710 and other pertinent information. After using PVC purchase form 2702 to enter credit card information, consumer viner 102 selects the get PVC button 2712 to submit the payment information. The payment information is then sent either to an internal or external payment gateway (not shown) that charges the credit card. After successful confirmation of the charge, the system allocates the amount of PVC that has been purchased to consumer viner 102's account.

As consumer viner 102 consummates video content transactions, appropriate PVC amounts are deducted from his or her account. Corresponding purchased or rented video content is then appears in the consumer's assigned channel C-8 for subsequent viewing access.

Thus, the transactional social media platform of the present invention provides a video content online shopping mall, where video vendors can open their own online and mobile video content store to rent or sell video content to consumers. Unlike conventional systems that have failed to recognize the long-felt need that consumers wish to purchase directly from video content providers, the present invention provides an “online and mobile direct-to-consumer” platform for consummating video content sales and rentals within a social media platform context. Moreover, consumers are also compensated for transactions that result from the referring and promoting video content unlike traditional content providers that either do not compensate users or provide inconsequential incentives to users.

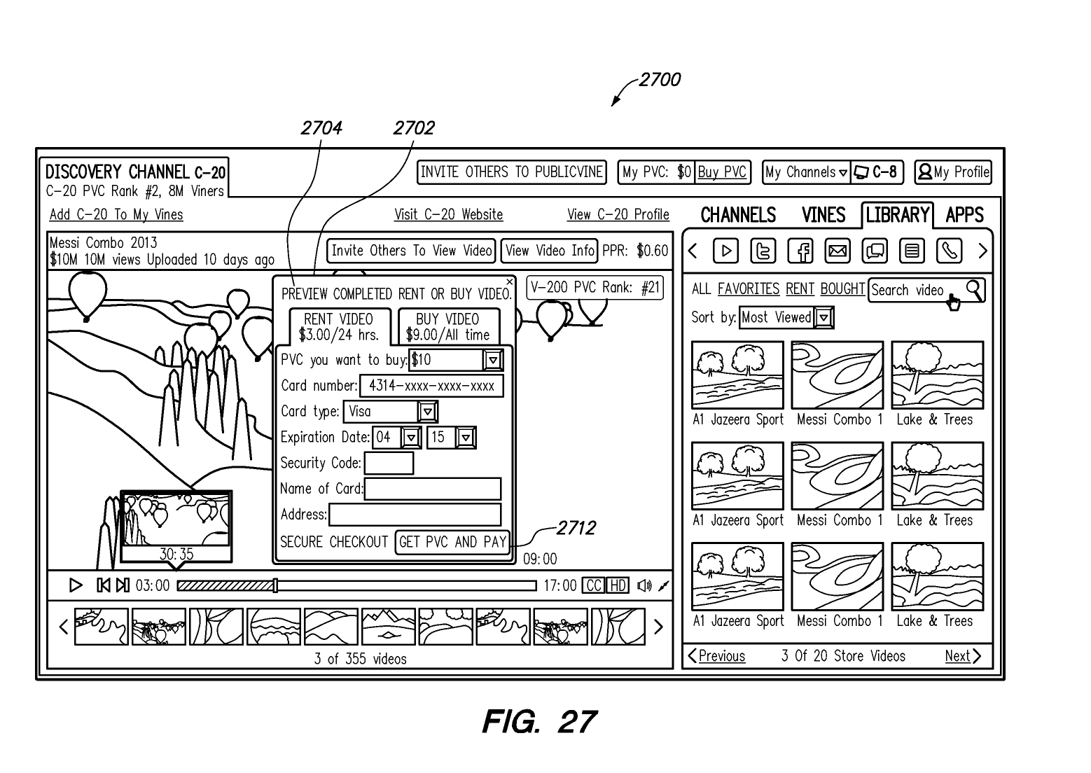

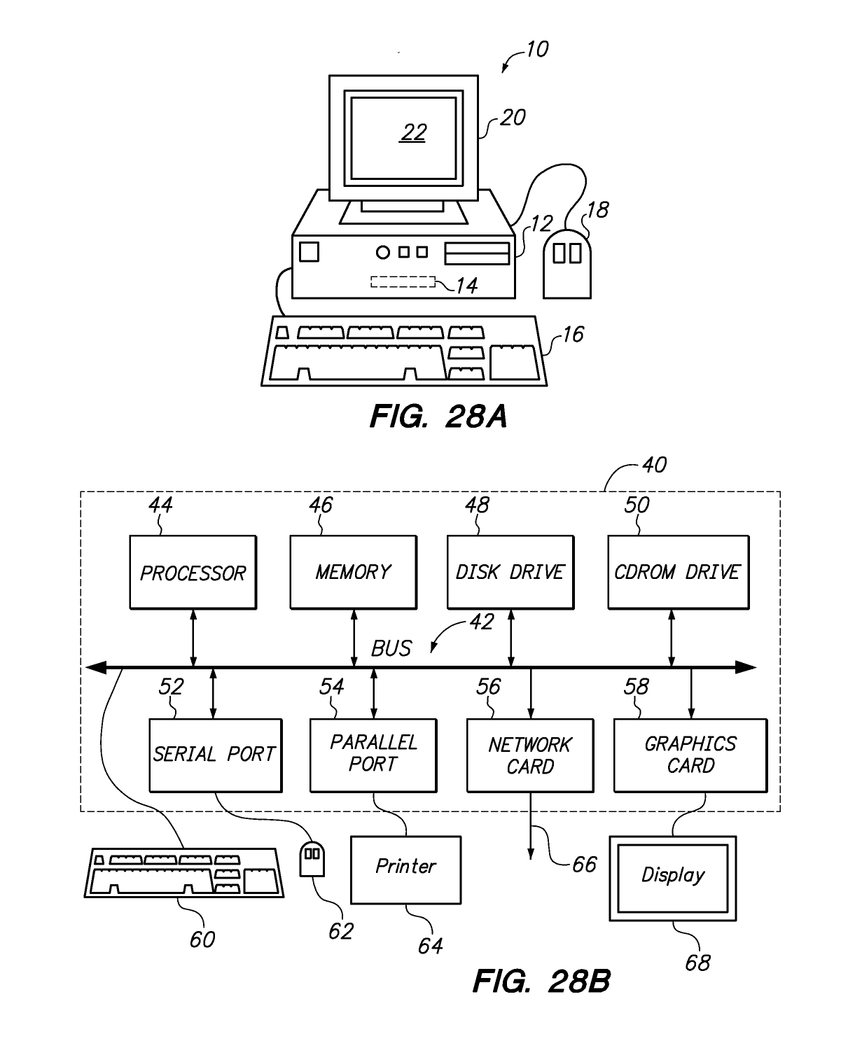

FIG. 28A shows a typical computer 10 (or mobile communication device) such as would be operated by a user on the Internet. Although not shown, a mobile communication device may also have applicable components of computer 10. Computer 10 includes a cabinet 12 housing familiar computer components such as a processor, memory, disk drive, Compact Digital Read-Only Memory (CDROM), etc. (not shown). User input devices include keyboard 16 and mouse 18. Output devices include display 20 having a display screen 22. Naturally, many other configurations of a computer system are possible. Some computer systems may have other components in addition to those shown in FIG. 28A while others will have fewer components. For example, server computers need not have attached input and output devices since they may only be accessed from time to time by other computers over a network. Human interaction with such a server computer can be at another computer that is equipped with input and output devices. Input and output devices exist in many variations from those shown in FIG. 28A. Displays can be liquid crystal displays (LCD), computer monitors, plasma, etc. Input devices can include a trackball, digitizing tablet, microphone, etc. In general, use of the term “input device” is intended to include all possible types of devices and ways to input information into a computer system or onto a network. Likewise, the term “output device” includes all possible types of devices and ways to output information from a computer system to a human or to another machine. The computer itself can be of varying types including laptop, mobile devices, notebook, palm-top, pen top, etc. The computer may not resemble the computer of FIG. 28A as in the case where a processor is embedded into another device or appliance such as an automobile or a cellular telephone. Because of the ever-changing nature of computers and networks, the description of hardware in this specification is intended only by way of example for the purpose of illustrating the preferred embodiment. Any distributed networked system capable of executing programmed instructions is suitable for use with the present invention.

FIG. 28B shows subsystems of the computer of FIG. 28A. In FIG. 28B, subsystems within box 40 are internal to, for example, the cabinet 12 of FIG. 28A. Bus 42 is used to transfer information in the form of digital data between processor 44, memory 46, disk drive 48, CDROM drive 50, serial port 52, parallel port 54, network card 56 and graphics card 58. Many other subsystems may be included in an arbitrary computer system, and some of the subsystems shown in FIG. 28B may be omitted. External devices can connect to the computer system's bus (or another bus or line, not shown) to exchange information with the subsystems in box 40. For example, devices such as keyboard 60 can communicate with processor 44 via dedicated ports and drivers (shown symbolically as a direct connection to bus 42). Mouse 62 is connected to serial port 52. Devices such as printer 64 can connect through parallel port 54. Network card 56 can connect the computer system to a network. Display 68 is updated via graphics card 58. Again, many configurations of subsystems and external devices are possible.

While the above is a complete description of exemplary specific embodiments of the invention, additional embodiments are also possible. Thus, the above description should not be taken as limiting the scope of the invention, which is defined by the appended claims along with their full scope of equivalents.

I claim:

1. A method comprising:
by one or more processors associated with one or more computing devices, establishing a social graph comprising a plurality of nodes and a plurality of edges connecting the nodes, each of one of said nodes being associated with one of a plurality of users of an online social network, each connection between two nodes representing a relationship between the two nodes and establishing a degree of separation between the two nodes;
by one or more of the processors, creating two user categories and grouping the plurality of users of the online social network into said two user categories: 1) vendors or vendor accounts that are configured to upload video content to the online social network, wherein upon request from the vendor to upload video content, the vendor is granted access to upload said video content; and 2) consumers or consumer accounts that are configured to prevent uploading of video content to the online social network, wherein upon request by the consumer to upload video content, said consumer is denied access to upload said video content;
by one or more of the processors, determining, a price that is paid by the consumer for each of one or more video content associated with the vendor of the online social network, the vendor being associated with a first node of the plurality of nodes of the online social network;
by one or more of the processors, receiving a request from the consumer of the online social network, to purchase one of said video content associated with the vendor and hosted by the online social network, the consumer being associated with a second node of the plurality of nodes; and
by one or more of the processors, granting the consumer access to the requested video content; and automatically charging or deducting from an account of the consumer of the online social network, the determined price of the video content transmitted to the consumer.

2. The method of claim 1 further comprising
by one or more of the processors, creating for each and every vendor of the online social network, a unique channel configured to be a uniform resource locator home address of the vendor, assigning the vendor channel exclusively to the vendor, wherein the vendor channel is configured to store all of the video content associated with the vendor; and
by one or more of the processors, creating for each and every consumer, a unique channel configured to be a uniform resource locator home address of the consumer, assigning the consumer channel exclusively to the consumer, wherein the vendor channel is a library configured to store access to of the video content purchased from vendors.

3. The method of claim 1 further comprising
by one or more of the processors, automatically determining without user intervention, the price paid by the consumer for each of one or more video content items associated with the vendor of the online social network, by using an algorithm that generates a BASE (Bandwidth Storage Encoding) cost based on the cost for bandwidth, storage, and encoding of the video content.

4. The method of claim 1 further comprising
by one or more of the processors, automatically determining without user intervention, the price that is paid by the consumer for each of one or more video content associated with the vendor of the online social network, by using an algorithm that generates a BASE (Bandwidth Storage Encoding) cost based on at least the cost for bandwidth (BA) determined according to the following equation:
BA=c_{b}max{sₑₗ, . . . ,s_{e|E|}}
where c_{b} is the cost of bandwidth per MB; and max{sₑₗ, . . . , s_{e|E|}} represents size (largest encoded video).

5. The method of claim 1 further comprising
by one or more of the processors, automatically determining without user intervention, the price that is paid by the consumer for each of one or more video content associated with the vendor of the online social network, by using an algorithm that generates a BASE (Bandwidth Storage Encoding) cost based on at least the cost for storage (S) determined according to the following equation:
$$S = \frac{{c}_{s} ( {s}_{u} + {Σ}_{v ∈ E} {s}_{v} )}{S P S}$$
where cₛ is the cost of monthly storage of all video content on system per megabyte; sᵤ is the size of uploaded video content from the vendor; v is a generic video variable; E is a set of all encoded video content; sᵥ is size of video v and SPS is a constant=10, the number of monthly views over which to spread monthly storage cost.

6. The method of claim 1 further comprising
by one or more of the processors, automatically determining without user intervention, the price that is paid by the consumer for each of one or more video content associated with the vendor of the online social network, by using an algorithm that generates a BASE (Bandwidth Storage Encoding) cost based on at least the encoding cost (E) of the video content is determined according to the following equation:
$$S = \frac{{d}_{u} ( {c}_{e} \vert S \vert + {c}_{h} \vert H \vert )}{S P E}$$
where dᵤ is duration of uploaded video rounded to the nearest minute; cₑ is the cost of standard definition encoding per min ($); |S| is the quantity of all standard definition encoded videos; cₕ is cost of HD encoding per min ($); |H| is quantity of all HD encoded videos; and SPE is a constant=100, the number of monthly views over which to spread one-time encoding cost.

7. The method of claim 1 further comprising
by one or more of the processors, automatically determining without user intervention, the price that is paid by the consumer for each of one or more video content items associated with the vendor of the online social network, by using an algorithm that generates a BASE (Bandwidth Storage Encoding) cost based on the cost for bandwidth, storage, and encoding of the video content according to the following equation:
$$BASE = {c}_{b} max \{ {s}_{e 1} , … , {s}_{e \vert E \vert} \} + \frac{{c}_{s} ( {s}_{u} + {Σ}_{v ∈ E} {s}_{v} )}{S P S} + \frac{{d}_{u} ( {c}_{e} \vert S \vert + {c}_{h} \vert H \vert )}{S P E}$$
where cₕ is the cost of bandwidth per MB; max{sₑₗ, . . . , s_{e|E|}} represents size (largest encoded video); cₛ is the cost of monthly storage of all video content on system per megabyte; sᵤ is the size of uploaded video content from the vendor; v is a generic video variable; E is a set of all encoded video content; sᵥ is size of encoded video v and SPS is a constant=10, the number of monthly views over which to spread monthly storage cost; dᵤ is duration of uploaded video rounded to the nearest minute; cₑ is the cost of standard definition encoding per min ($); |S| is the quantity of all standard definition encoded videos; cₕ is cost of HD encoding per min ($); |H| is quantity of all HD encoded videos; and SPE is a constant=100, the number of monthly views over which to spread one-time encoding cost.

8. A computer program product including a computer readable storage medium and including computer executable code which when executed by a processor is adapted to:
establish a social graph comprising a plurality of nodes and a plurality of edges connecting the nodes, each of one of said nodes being associated with one of a plurality of users of an online social network, each connection between two nodes representing a relationship between the two nodes and establishing a degree of separation between the two nodes;
create at least two user categories and group the plurality of users of the online social network into said at least two categories: 1) vendors or vendor accounts that are configured to upload video content to the online social network, wherein upon request from the vendor to upload video content, the vendor is granted access to upload said video content; and 2) consumers or consumer accounts that are configured to prevent uploading of video content to the online social network, wherein upon request by the consumer to upload video content, said consumer is denied access to upload said video content;
determine, a price that is paid by the consumer for each of one or more video content associated with the vendor of the online social network, the vendor being associated with a first node of the plurality of nodes of the online social network;
receive a request from the consumer of the online social network, to purchase one of said video content associated with the vendor and hosted by the online social network, the consumer being associated with a second node of the plurality of nodes; and
grant the consumer access to the requested video content; and automatically charge or deduct from an account of the consumer of the online social network, the determined cost of the video content accessed by consumer.

9. The computer program product of claim 8 further comprising
create for each and every vendor of the online social network, a unique channel configured to be a uniform resource locator home address of the vendor, assigning the vendor channel exclusively to the vendor, wherein the vendor channel is configured to store all of the video content associated with the vendor; and
creating for each and every consumer, a unique channel configured to be a uniform resource locator home address of the consumer, assigning the consumer channel exclusively to the consumer, wherein the consumer channel is a library configured to provide store access to the video content purchased from vendors.

10. The computer product code of claim 8 further comprising
automatically determine without user intervention, the price that is paid by the consumer for each of one or more video content items associated with the vendor of the online social network, by using an algorithm that generates a BASE (Bandwidth Storage Encoding) cost based on the cost for bandwidth, storage, and encoding of the video content.

11. The computer product code of claim 8 further comprising
automatically determine without user intervention, the price that is paid by the consumer for each of one or more video content associated with the vendor of the online social network, by using an algorithm that generates a BASE (Bandwidth Storage Encoding) cost based on at least the cost for bandwidth (BA) determined according to the following equation:
BA=c_{b}max{sₑₗ, . . . ,s_{e|E|}}
where c_{b} is the cost of bandwidth per MB; and max{sₑ₁, . . . , s_{e|E|}} represents size (largest encoded video).

12. The computer product code of claim 8 further comprising
automatically determine without user intervention, the price that is paid by the consumer for each of one or more video content associated with the vendor of the online social network, by using an algorithm that generates a BASE (Bandwidth Storage Encoding) cost based on at least the cost for storage (S) determined according to the following equation:
$$S = \frac{{c}_{s} ( {s}_{u} + {Σ}_{v ∈ E} {s}_{v} )}{S P S}$$
where cₛ is the cost of monthly storage of all video content on system per megabyte; sᵤ is the size of uploaded video content from the vendor; v is a generic video variable; E is a set of all encoded video content; sᵥ is the size of the video v; and SPS is a constant=10, the number of monthly views over which to spread monthly storage cost.

13. The computer product code of claim 8 further comprising
automatically determine without user intervention, the price that is paid by the consumer for each of one or more video content associated with the vendor of the online social network, by using an algorithm that generates a BASE (Bandwidth Storage Encoding) cost based on at least the encoding cost (E) of the video content is determined according to the following equation:
$$S = \frac{{d}_{u} ( {c}_{e} \vert S \vert + {c}_{h} \vert H \vert )}{S P E}$$
where dᵤ is duration of uploaded video rounded to the nearest minute; cₑ is the cost of standard definition encoding per min ($); |S| is the quantity of all standard definition encoded videos; cₕ is cost of HD encoding per min ($); |H| is quantity of all HD encoded videos; and SPE is a constant=100, the number of monthly views over which to spread one-time encoding cost.

14. The computer product code of claim 8 further comprising
automatically determine without user intervention, the price that is paid by the consumer for each of one or more video content items associated with the vendor of the online social network, by using an algorithm that generates a BASE (Bandwidth Storage Encoding) cost based on the cost for bandwidth, storage, and encoding of the video content according to the following equation:
$$BASE = {c}_{b} max \{ {s}_{e 1} , … , {s}_{e \vert E \vert} \} + \frac{{c}_{s} ( {s}_{u} + {Σ}_{v ∈ E} {s}_{v} )}{S P S} + \frac{{d}_{u} ( {c}_{e} \vert S \vert + {c}_{h} \vert H \vert )}{S P E}$$
where cₕ is the cost of bandwidth per MB; max{sₑ₁, . . . , s_{e|E|}} represents size (largest encoded video); cₛ is the cost of monthly storage of all video content on system per megabyte; sᵤ is the size of uploaded video content from the vendor; v is a generic video variable; E is a set of all encoded video content; sᵥ is size of encoded video v and SPS is a constant=10, the number of monthly views over which to spread monthly storage cost; dᵤ is duration of uploaded video rounded to the nearest minute; cₑ is the cost of standard definition encoding per min ($); |S| is the quantity of all standard definition encoded videos; cₕ is cost of HD encoding per min ($); |H| is quantity of all HD encoded videos; and SPE is a constant=100, the number of monthly views over which to spread one-time encoding cost.

15. A system including one or more processors operable to execute computer executable code to:
establish a social graph comprising a plurality of nodes and a plurality of edges connecting the nodes, each of one of said nodes being associated with one of a plurality of users of an online social network, each connection between two nodes representing a relationship between the two nodes and establishing a degree of separation between the two nodes;
create at least two user categories and classify the plurality of users of the online social network into said at least two categories: 1) vendors or vendor accounts that are configured to upload video content to the online social network, wherein upon request from the vendor to upload video content, the vendor is granted access to upload said video content; and 2) consumers or consumer accounts that are configured to prevent uploading of video content to the online social network, wherein upon request by the consumer to upload video content, said consumer is denied access to upload said video content;
determine, a price that is paid by the consumer for each of one or more video content associated with the vendor of the online social network, the vendor being associated with a first node of the plurality of nodes of the online social network;
receive a request from the consumer of the online social network, to purchase one of said video content associated with the vendor and hosted by the online social network, the consumer being associated with a second node of the plurality of nodes; and
grant the consumer access to the requested video content; and automatically charging or deducting from an account of the consumer of the online social network, the determined cost of the video content transmitted to the consumer.

16. The system of claim 15 further comprising
create for each and every vendor of the online social network, a unique channel configured to be a uniform resource locator home address of the vendor, assigning the vendor channel exclusively to the vendor, wherein the vendor channel is configured to store all of the video content associated with the vendor; and
create for each and every consumer, a unique channel configured to be a uniform resource locator home address of the consumer, assigning the consumer channel exclusively to the consumer, wherein the vendor channel is a library configured to store access to of the video content purchased from vendors.

17. The system of claim 15 further comprising
determine the price that is paid by the consumer for each of one or more video content items associated with the vendor of the online social network, by using an algorithm that generates a BASE (Bandwidth Storage Encoding) cost based on the cost for bandwidth, storage, and encoding of the video content.

18. The system of claim 15 further comprising
automatically determine without user intervention, the price that is paid by the consumer for each of one or more video content associated with the vendor of the online social network, sᵥ by using an algorithm that generates a BASE (Bandwidth Storage Encoding) cost based on at least the cost for storage (S) determined according to the following equation:
$$S = \frac{{c}_{s} ( {s}_{u} + {Σ}_{v ∈ E} {s}_{v} )}{S P S}$$
where cₛ is the cost of monthly storage of all video content on system per megabyte; sᵤ is the size of uploaded video content from the vendor; v is a generic video variable; E is a set of all encoded video content; sᵥ is the size of video v; and SPS is a constant=10, the number of monthly views over which to spread monthly storage cost.

19. The system of claim 15 further comprising
automatically determine without user intervention, the price that is paid by the consumer for each of one or more video content items associated with the vendor of the online social network, by using an algorithm that generates a BASE (Bandwidth Storage Encoding) cost based on the cost for bandwidth, storage, and encoding of the video content according to the following equation:
$$BASE = {c}_{b} max \{ {s}_{e 1} , … , {s}_{e \vert E \vert} \} + \frac{{c}_{s} ( {s}_{u} + {Σ}_{v ∈ E} {s}_{v} )}{S P S} + \frac{{d}_{u} ( {c}_{e} \vert S \vert + {c}_{h} \vert H \vert )}{S P E}$$
where cₕ is the cost of bandwidth per MB; max{sₑ₁, . . . , s_{e|E|}} represents size (largest encoded video); cₛ is the cost of monthly storage of all video content on system per megabyte; sᵤ is the size of uploaded video content from the vendor; v is a generic video variable; E is a set of all encoded video content; sᵥ is size of encoded video v and SPS is a constant=10, the number of monthly views over which to spread monthly storage cost; dᵤ is duration of uploaded video rounded to the nearest minute; cₑ is the cost of standard definition encoding per min ($); |S| is the quantity of all standard definition encoded videos; cₕ is cost of HD encoding per min ($); |H| is quantity of all HD encoded videos; and SPE is a constant=100, the number of monthly views over which to spread one-time encoding cost.

20. The method of claim 1 wherein the online social network is based on a mobile network.
